(19) United States
(12) Patent Application Publication
(10) Pub. No.: US 2024/0166869 A1
(43) Pub. Date: May 23, 2024

(54) COMPOSITION FOR PREPARING FOAM, METHODS ASSOCIATED THEREWITH, AND FOAM FORMED THEREFROM

(71) Applicants: DOW SILICONES CORPORATION, Midland, MI (US); DOW GLOBAL TECHNOLOGIES LLC, Midland, MI (US)

(72) Inventors: Zhengming TANG, Shanghai (CN); Sudhakar BALIJEPALLI, Midland, MI (US); Rosella RICCIO, Corregio (IT); Sachit GOYAL, Lake Jackson, TX (US)

(73) Assignees: DOW SILICONES CORPORATION, Midland, MI (US); DOW GLOBAL TECHNOLOGIES LLC, Midland, MI (US)

(21) Appl. No.: 18/282,062

(22) PCT Filed: Mar. 17, 2022
(86) PCT No.: PCT/CN2022/081491

§ 371 Date: Sep. 14, 2023

(30) Foreign Application Priority Data
Mar. 17, 2021 (WO) PCT/CN2021/081195

(51) Int. Cl. C08L 75/06; C08J 9/00; C08J 9/14

(52) U.S. Cl. CPC C08L 75/06; C08J 9/0061; C08J 9/141; C08J 9/146; C08J 2203/10; C08J 2203/14; C08J 2203/162; C08J 2375/06; C08J 2483/04; C08L 2203/14

(57) ABSTRACT

A composition for preparing a foam comprises (A) a polyol, (B) a pre-mixture comprising (B1) a silicone resin at least partially solubilized in (B2) a physical blowing agent capable of at least partially solubilizing the silicone resin (B1), (C) a polyisocyanate, and (D) a catalyst. The silicone resin (B1) includes at least 20 mol % (R¹₃SiO_{1/2}) siloxy units and at least 40 mol % of (SiO_{4/2}) siloxy units, each based on the total moles of siloxy units present in the silicone resin (B1), with the proviso that the combined amount of (R¹₃SiO_{1/2}) and (SiO_{4/2}) siloxy units is at least 85 mol % based on the total moles of siloxy units present in the silicone resin (B1), where each R¹ is independently a substituted or unsubstituted hydrocarbyl group.

### CROSS REFERENCE TO RELATED APPLICATIONS

This application claims priority to and all advantages of International PCT Application No. PCT/CN2021/081195 filed on 17 Mar. 2021, the content of which is incorporated herein by reference.

### TECHNICAL FIELD

The subject disclosure generally relates to a composition and, more specifically, to a composition for preparing a foam having excellent properties, including density and thermal conductivity, and to the foam formed with the composition.

### BACKGROUND

Foams are known in the art and utilized in various end use applications, including insulation. Foams can be formed from various chemical compositions, and may utilize physical and/or chemical blowing agents. For example, polyisocyanurate (PIR) foams are generally formed by reacting an isocyanate and a polyol in the presence of a blowing agent at an isocyanate index of at least 130. Performance properties of foams, including hardness, density, flexibility, etc., are a function of the composition utilized in their preparation. In many end use applications of foams, it is desirable to minimize thermal conductivity and without deleteriously impacting density. For example, thermal conductivity can be minimized by simply reducing density of a foam. However, the reduction in density can make the foam unsuitable for various end use applications. Thus, it is difficult to prepare foams having both excellent density and thermal conductivity.

### BRIEF SUMMARY

A composition for preparing a foam is disclosed. The composition comprises (A) a polyol, (B) a pre-mixture comprising (B1) a silicone resin at least partially solubilized in (B2) a physical blowing agent capable of at least partially solubilizing the silicone resin (B1), (C) a polyisocyanate, and (D) a catalyst. The silicone resin (B1) includes at least 20 mol % (R¹₃SiO_{1/2}) siloxy units and at least 40 mol % of (SiO_{4/2}) siloxy units, each based on the total moles of siloxy units present in the silicone resin (B1), with the proviso that the combined amount of (R¹₃SiO_{1/2}) and (SiO_{4/2}) siloxy units is at least 85 mol % based on the total moles of siloxy units present in the silicone resin (B1), where each R¹ is independently a substituted or unsubstituted hydrocarbyl group.

A method of preparing the composition is also disclosed. The method comprises contacting the silicone resin (B1) and the physical blowing agent (B2) to give the pre-mixture (B), and combining the pre-mixture (B) with components (A), (C), and (D) to give the composition.

A method of preparing a foam is also disclosed. The method comprises mixing the composition and curing the composition to give the foam. The foam comprising the reaction product of the composition is also disclosed.

### DETAILED DESCRIPTION OF THE INVENTION

A composition for preparing a foam is disclosed. The foam formed with the composition has excellent physical properties and is suitable for diverse end use applications, as described below.

The composition comprises (A) a polyol. The polyol (A) is not limited and can be any conventional polyol so long as the polyol (A) is capable of reacting with an isocyanate, as described below.

In certain embodiments, the polyol (A) comprises a polyether polyol. Polyether polyols suitable for the composition include, but are not limited to, products obtained by the polymerization of a cyclic oxide, for example, ethylene oxide (“EO”), propylene oxide (“PO”), butylene oxide (“BO”), tetrahydrofuran, or epichlorohydrin, in the presence of polyfunctional initiators. Suitable initiators contain a plurality of active hydrogen atoms. Catalysis for this polymerization to give polyether polyols can be either anionic or cationic, with catalysts such as KOH, CsOH, boron trifluoride, a double metal cyanide complex (DMC) catalyst (e.g. zinc hexacyanocobaltate), or a quaternary phosphazenium compound. The initiator may be selected from, for example, neopentylglycol; 1,2-propylene glycol; water; trimethylolpropane; pentaerythritol; sorbitol; sucrose; glycerol; aminoalcohols, such as ethanolamine, diethanolamine, and triethanolamine; alkanediols, such as 1,6-hexanediol, 1,4-butanediol, 1,3-butane diol, 2,3-butanediol, 1,3-propanediol, 1,2-propanediol, 1,5-pentanediol, 2-methylpropane-1,3-diol, 1,4-cyclohexane diol, 1,3-cyclohexanedimethanol, 1,4-cyclohexanedimethanol, 2,5-hexanediol; ethylene glycol; diethylene glycol; triethylene glycol; bis-3-aminopropyl methylamine; ethylene diamine; diethylene triamine; 9(1)-hydroxymethyloctadecanol, 1,4-bishydroxymethylcyclohexane; hydrogenated bisphenol; 9,9(10,10)-bishydroxymethyloctadecanol; 1,2,6-hexanetriol, and combinations thereof. Other initiators include other linear and cyclic compounds containing an amine group. Exemplary polyamine initiators include ethylene diamine, neopentyldiamine, 1,6-diaminohexane; bisaminomethyltricyclodecane; bisaminocyclohexane; diethylene triamine; bis-3-aminopropyl methylamine; triethylene tetramine; various isomers of toluene diamine; diphenylmethane diamine; N-methyl-1,2-ethanediamine, N-methyl-1,3-propanediamine; N,N-dimethyl-1,3-diaminopropane; N,N-dimethylethanolamine; 3,3′-diamino-N-methyldipropylamine; N,N-dimethyldipropylenetriamine; aminopropyl-imidazole; and combinations thereof. As understood in the art, the initiator compound, or combinations thereof, is generally selected based on desired functionality of the resulting polyether polyol. For the purposes of this disclosure, the polyol (A) may be formed with any of the initiators mentioned above, or combinations of initiators. In addition, the polyol (A) may comprise any of these initiators, including glycerol.

Other suitable polyether polyols include polyether diols and triols, such as polyoxypropylene diols and triols and poly(oxyethylene-oxypropylene)diols and triols obtained by the simultaneous or sequential addition of ethylene and propylene oxides to di-or trifunctional initiators. Polyether polyols having higher functionalities than triols can also be utilized in lieu of or in addition to polyether diols and/or triols. Copolymers having oxyethylene contents of from 5 to 90% by weight, based on the weight of the polyol (A), of which the polyols may be block copolymers, random/block copolymers or random copolymers, can also be used. Yet other suitable polyether polyols include polytetramethylene glycols obtained by the polymerization of tetrahydrofuran.

In these or other embodiments, the polyol (A) comprises a polyester polyol. Polyester polyols suitable for the composition include, but are not limited to, hydroxyl-functional reaction products of polyhydric alcohols, such as ethylene glycol, propylene glycol, diethylene glycol, 1,4-butanediol, neopentylglycol, 1,6-hexanediol, cyclohexane dimethanol, glycerol, trimethylolpropane, pentaerythritol, sucrose, or polyether polyols or mixtures of such polyhydric alcohols, and polycarboxylic acids, particularly dicarboxylic acids or their ester-forming derivatives, for example succinic, glutaric and adipic acids or their dimethyl esters, sebacic acid, phthalic anhydride, tetrachlorophthalic anhydride, dimethyl terephthalate or mixtures thereof. Polyester polyols obtained by the polymerization of lactones, e.g. caprolactone, in conjunction with a polyol, or of hydroxy carboxylic acids, e.g. hydroxy caproic acid, may also be used. In certain embodiments, the polyol (A) comprises a mixture of polyester and polyether polyols.

Suitable polyesteramide polyols may be obtained by the inclusion of aminoalcohols such as ethanolamine in polyesterification mixtures. Suitable polythioether polyols include products obtained by condensing thiodiglycol either alone or with other glycols, alkylene oxides, dicarboxylic acids, formaldehyde, aminoalcohols or aminocarboxylic acids. Suitable polycarbonate polyols include products obtained by reacting diols such as 1,3-propanediol, 1,4-butanediol, 1,6-hexanediol, diethylene glycol or tetraethylene glycol with diaryl carbonates, e.g. diphenyl carbonate, or with phosgene. Suitable polyacetal polyols include those prepared by reacting glycols such as diethylene glycol, triethylene glycol or hexanediol with formaldehyde. Other suitable polyacetal polyols may also be prepared by polymerizing cyclic acetals. Suitable polyolefin polyols include hydroxy-terminated butadiene homo- and copolymers.

In certain embodiments, the polyol (A) comprises a polymer polyol. In specific embodiments, the polymer polyol is a graft polyol. Graft polyols may also be referred to as graft dispersion polyols or graft polymer polyols. Graft polyols often include products, i.e., polymeric particles, obtained by the in-situ polymerization of one or more vinyl monomers, e.g. styrene monomers and/or acrylonitrile monomers, and a macromer in a polyol, e.g. a polyether polyol.

It is to be appreciated that the composition may include any combination of two or more polyols that are different from one another based on functionality, molecular weight, viscosity, or structure.

In various embodiments, the polyol (A) has a hydroxyl (OH) equivalent weight of from greater than 0 to 2,000, alternatively from greater than 0 to 1,700, alternatively from greater than 0 to 1,000, alternatively from greater than 0 to 700, alternatively from greater than 0 to 400, alternatively from greater than 0 to 350, alternatively from greater than 0 to 325, alternatively from greater than 0 to 300, alternatively from greater than 0 to 275, alternatively from greater than 0 to 250, g/equiv. In certain embodiments, including the ranges above, the OH equivalent weight of the polyol (A) is at least 30 g/equiv. Methods of determining OH equivalent weight are known in the art based on functionality and molecular weight of a given polyol.

In these or other embodiments, the polyol has a functionality of from 2 to 10, alternatively from 2 to 9, alternatively from 2 to 8, alternatively from 2 to 7, alternatively from 3 to 6.

In specific embodiments, the polyol (A) comprises, alternatively consists essentially of, alternatively consists of, one or more polyester polyols, optionally in combination with one or more polyether polyols.

It is to be appreciated that when the polyol (A) comprises a blend of two or more different polyols, the properties above may be based on the overall polyol (A), i.e., averaging the properties of the individual polyols in the polyol (A), or may relate to a specific polyol in the blend of polyols. Typically, the properties above relate to the overall polyol (A).

The composition further comprises (B) a pre-mixture comprising (B1) a silicone resin at least partially solubilized in (B2) a physical blowing agent capable of at least partially solubilizing the silicone resin (B1). The pre-mixture (B) is formed prior to forming the composition. Said differently, the pre-mixture (B) is not formed in situ by combining components (B1) and (B2) along with the other components in forming the composition. Instead, it is the pre-mixture (B) itself that is combined with the other components to give the composition. Surprisingly, it has been found that use of the pre-mixture (B), rather than use of components (B1) and (B2) in the absence of the pre-mixture (B), impacts properties in the resulting foam.

The pre-mixture (B) can be formed in any way. For example, the silicone resin (B1) may be disposed in the physical blowing agent (B2), or the physical blowing agent (B2) may be disposed in the silicone resin (B1), etc. The silicone resin (B1) is at least partially solubilized in the physical blowing agent (B2). For example, the pre-mixture (B) can be a heterogeneous mixture or dispersion of the silicone resin (B1) in the physical blowing agent (B2). Typically, however, the silicone resin (B1) is solubilized in the physical blowing agent (B2) such that the pre-mixture (B) is a solution, and in particularly a homogenous solution.

As understood by those of skill in the art, silicone resins may be characterized in terms of [M], [D], [T], and/or [Q] units/siloxy groups therein. More specifically, these [M], [D], [T], and [Q] siloxy groups each represent structural units present in organopolysiloxanes, including silicone resins. In particular, [M] represents a monofunctional unit of general formula R″₃ SiO_{1/2}; [D] represents a difunctional unit of general formula R″₂ SiO_{2/2}; [T] represents a trifunctional unit of general formula R″SiO_{3/2}; and [Q] represents a tetrafunctional unit of general formula SiO_{4/2}, as shown by the general structural moieties below:

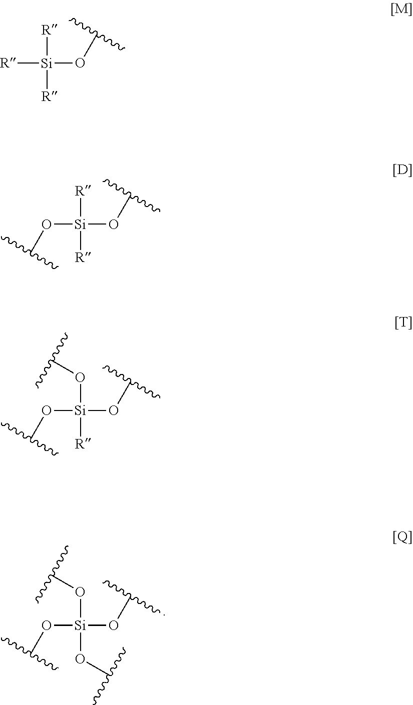

In these general structural moieties, each R″ is independently a monovalent or polyvalent substituent. As understood in the art, specific substituents suitable for each R″ are not particularly limited, and may be monoatomic or polyatomic, organic or inorganic, linear or branched, substituted or unsubstituted, aromatic, aliphatic, saturated or unsaturated, and combinations thereof.

The silicone resin (B1) includes at least 20 mol % (R¹₃SiO_{1/2}) siloxy units and at least 40 mol % of (SiO_{4/2}) siloxy units, each based on the total moles of siloxy units present in the silicone resin (B1). The combined amount of (R¹₃SiO_{1/2}) and (SiO_{4/2}) siloxy units is at least 85 mol % based on the total moles of siloxy units present in the silicone resin (B1), where each R¹ is independently a substituted or unsubstituted hydrocarbyl group. Thus, the silicone resin (B1) includes at least 20 mol % M siloxy units and at least 40 mol % Q siloxy units, with a combined amount of M and Q units accounting for at least 85 mol %, each based on the total moles of siloxy units in the silicone resin (B1). However, conventionally, M units were defined as being trimethylsiloxy units, and it is to be appreciated that R¹ can be something other than methyl, but (R¹₃SiO_{1/2}) siloxy units are still considered M units for purposes of this disclosure.

Because at least 85 mol % of all siloxy units are M and Q siloxy units in the silicone resin (B1), the silicone resin (B1) may be categorized or otherwise referred to as an MQ resin. Such MQ resins are known in the art as macromolecular resins primarily comprising M and Q units and optionally a limited number of D and/or T units (e.g. ≤15 mol %, total). In certain embodiments, the silicone resin (B1) is a solid (e.g. powder or flake) form at 25° C. unless disposed in a solvent or the physical blowing agent (B2). These MQ resins are often designated simply by the general formula [M]ₓ[Q] where subscript x refers to the molar ratio of M siloxy units to Q siloxy units when the number of moles of Q siloxy units is normalized to 1. In such instances, the greater the value of x, the lesser the crosslink density of MQ resin. The inverse is also true as, when the value of x decreases, the number of M siloxy units decreases, and thus more Q siloxy units are networked without termination via an M siloxy unit. It will be appreciated, however, that the normalized content of Q siloxy units does not imply or limit MQ resins to only one Q unit. Rather, MQ resins typically includes a plurality of Q siloxy units clustered or bonded together, as will be appreciated from the description below.

In certain embodiments, the silicone resin (B1) has the following general formula:

(R¹₃SiO_{1/2})ₐ(R¹₂SiO_{2/2})_{b}(R′R¹ SiO_{2/2})_{b}′(R¹SiO_{3/2})_{c}(R′SiO_{3/2})_{c′}(SiO_{4/2})_{d},

wherein subscripts a, b, b′, c, c′, and d are each mole fractions such that a+b+b′+c+c′+d=1, with the provisos that 0.2≤a≤0.6, 0≤b≤0.1, 0≤b≤′0.1, 0≤c≤0.1, 0≤c′≤0.1, 0.4≤d≤0.8, and 0.85≤a+d≤1.0; wherein each R¹ is independently selected and defined above, and wherein each R′ comprises an independently selected amino group.

With reference to the general formula of the silicone resin (B1) above, hydrocarbyl groups suitable for R¹ include monovalent hydrocarbon moieties, as well as derivatives and modifications thereof, which may independently be substituted or unsubstituted, linear, branched, cyclic, or combinations thereof, and saturated or unsaturated. The term “substituted” describes hydrocarbon moieties where at least one hydrogen atom is replaced with an atom or group other than hydrogen (e.g. a halogen atom, etc.). Linear and branched hydrocarbyl groups may independently be saturated or unsaturated and, when unsaturated, may be conjugated or nonconjugated. Cyclic hydrocarbyl groups may independently be monocyclic or polycyclic, and encompass cycloalkyl groups, aryl groups, and heterocycles, which may be aromatic, saturated and nonaromatic and/or non-conjugated, etc. Examples of combinations of linear and cyclic hydrocarbyl groups include alkaryl groups, aralkyl groups, etc. General examples of hydrocarbon moieties suitably for use in or as the hydrocarbyl group include alkyl groups, aryl groups, alkenyl groups, alkynyl groups, halocarbon groups, and the like, as well as derivatives, modifications, and combinations thereof. Examples of alkyl groups include methyl, ethyl, propyl (e.g. iso-propyl and/or n-propyl), butyl (e.g. isobutyl, n-butyl, tert-butyl, and/or sec-butyl), pentyl (e.g. isopentyl, neopentyl, and/or tert-pentyl), hexyl, and the like (i.e., other linear or branched saturated hydrocarbon groups, e.g. having greater than 6 carbon atoms). Examples of aryl groups include phenyl, tolyl, xylyl, naphthyl, benzyl, dimethyl phenyl, and the like, as well as derivatives and modifications thereof, which may overlap with alkaryl groups (e.g. benzyl) and aralkyl groups (e.g. tolyl, dimethyl phenyl, etc.). Examples of alkenyl groups include vinyl, allyl, propenyl, isopropenyl, butenyl, isobutenyl, pentenyl, heptenyl, hexenyl, cyclohexenyl groups, and the like, as well as derivatives and modifications thereof. General examples of halocarbon groups include halogenated derivatives of the hydrocarbon moieties above, such as halogenated alkyl groups (e.g. any of the alkyl groups described above, where one or more hydrogen atoms is replaced with a halogen atom such as F or Cl), aryl groups (e.g. any of the aryl groups described above, where one or more hydrogen atoms is replaced with a halogen atom such as F or Cl), and combinations thereof. Examples of halogenated alkyl groups include fluoromethyl, 2-fluoropropyl, 3,3,3-trifluoropropyl, 4,4,4-trifluorobutyl, 4,4,4,3,3-pentafluorobutyl, 5,5,5,4,4,3,3-heptafluoropentyl, 6,6,6,5,5,4,4,3,3-nonafluorohexyl, and 8,8,8,7,7-pentafluorooctyl, 2,2-difluorocyclopropyl, 2,3-difluorocyclobutyl, 3,4-difluorocyclohexyl, 3,4-difluoro-5-methylcycloheptyl, chloromethyl, chloropropyl, 2-dichlorocyclopropyl, 2,3-dichlorocyclopentyl, and the like, as well as derivatives and modifications thereof. Examples of halogenated aryl groups include chlorobenzyl, pentafluorophenyl, fluorobenzyl groups, and the like, as well as derivatives and modifications thereof.

In certain embodiments, each R¹ is independently a substituted or unsubstituted hydrocarbyl group having from 1 to 30 carbon atoms. For example, in some such embodiments, the at least one R¹ is an independently selected substituted or unsubstituted alkyl group, such as an alkyl group having from 1 to 24, alternatively from 1 to 18, alternatively from 1 to 16, alternatively from 1 to 12, alternatively from 1 to 10, alternatively from 1 to 8, alternatively from 1 to 6, carbon atoms. Specific examples of alkyl groups include methyl groups, ethyl groups, propyl groups (e.g. n-propyl and iso-propyl groups), butyl groups (e.g. n-butyl, sec-butyl, iso-butyl, and tert-butyl groups), pentyl groups, hexyl groups, heptyl groups, etc., and the like, as well as derivatives and/or modifications thereof. Examples of derivatives and/or modifications of such alkyl groups include substituted versions thereof. Likewise, R¹ may comprise, alternatively may be, an independently selected substituted or unsubstituted alkenyl groups having from 2 to 6 carbon atoms, such as from 2 to 5, alternatively from 2 to 4, alternatively from 2 to 3 carbon atoms. In certain embodiments, the silicone resin (B1) comprises at least two R¹ groups comprising alkenyl functionality (i.e., at least two R¹ are selected from substituted or unsubstituted alkenyl groups). In these or other embodiments, each R¹ is independently selected from C1-C6 alkyl groups, aryl groups, alkenyl groups, phenyl groups, vinyl groups, and combinations thereof. In certain embodiments, the silicone resin (B1) includes both trimethylsiloxy units as M units and vinyldimethylsiloxy units as M units. In other embodiments, the silicone resin (B1) includes only trialkylsiloxy units as M units without silicon-bonded alkenyl functionality. In certain embodiments, at least 50, alternatively at least 60, alternatively at least 70, alternatively at least 80, alternatively at least 90, mol % of all R¹ groups are hydrocarbyl groups.

Each R′ independently comprises an amino group. In certain embodiments, each R′ is an amino group. The amino group of R′ may be of formula —N(H)_{f}R¹_{2-f}, where each R¹ is independently selected and defined above, i.e., each R¹ is an independently selected substituted or unsubstituted hydrocarbyl group, and where subscript f is independently 0, 1, or 2. In other embodiments, each R′ independently comprises a hydrocarbon group substituted with an amino group. Suitable hydrocarbon groups are described above. In specific embodiments, each R′ independently comprises an aliphatic hydrocarbon group substituted with an amino group. The aliphatic hydrocarbon group can be linear or cyclic, and is typically saturated. In specific embodiments, each R′ comprises an alkylamino group. For example, each R′ can be of formula —(CH₂)_{g}N(H)_{f}R^{2-f}, where each subscript g is independently from 1 to 30, alternatively from 1 to 25, alternatively from 1 to 20, alternatively from 1 to 15, alternatively from 1 to 10, alternatively from 1 to 8, alternatively from 1 to 6, alternatively from 1 to 4, alternatively from 2 to 4, and R¹ and subscript f are defined above. In specific embodiments, subscript g is 3 and subscript f is 2 such that each R′ is of formula —(CH₂)₃N(H)₂.

With continued reference to the general formula of the silicone resin (B1) above, subscripts a, b, b′, c, c′, and d are each mole fractions such that a+b+b′+c+c′+d=1. As will be appreciated by those of skill in the art, subscripts a, b, c, and d, correspond to M, D, T, and Q siloxy units, respectively. Both of subscripts b and b′ in the general formula above indicate D siloxy units, and both of subscripts c and c′ in the general formula above indicate T siloxy units, but with different silicon-bonded substituents (R¹ vs. R′), respectively. In certain embodiments, subscript b is ≤1.1, alternatively ≤0.09, alternatively ≤0.08, alternatively ≤0.07, alternatively ≤1.06, alternatively ≤0.05, alternatively ≤1.04, alternatively ≤1.03, alternatively ≤002, alternatively ≤0.01, alternatively 0. In these or other embodiments, subscript c is ≤0.1, alternatively ≤0.09, alternatively ≤0.08, alternatively ≤0.07, alternatively ≤0.06, alternatively ≤0.05, alternatively ≤0.04, alternatively ≤0.03, alternatively ≤002, alternatively ≤0.01, alternatively 0. In these or other embodiments, 0.25≤a≤0.55, alternatively 0.35≤a≤0.55 alternatively 0.35≤a≤0.5, alternatively 0.4≤a≤0.5. In these or other embodiments, 0.45≤d≤0.75, alternatively 0.45≤d≤0.7 alternatively 0.55≤d≤0.65, alternatively 0.5≤d≤0.6. In specific embodiments, subscript c′ is 0. In other embodiments, subscript c′ is from greater than 0 to 0.1, alternatively from greater than 0 to 0.05, alternatively from greater than 0 to 0.04, alternatively from 0.01 to 0.04. In other specific embodiments, subscript b′ is 0. In yet other embodiments, subscript b′ is from greater than 0 to 0.1, alternatively from greater than 0 to 0.05, alternatively from greater than 0 to 0.04, alternatively from 0.01 to 0.04. In further embodiments, b′ and c′ are each 0. In other embodiments, (b′+c′) is from greater than 0 to 0.1, alternatively from greater than 0 to 0.05, alternatively from greater than 0 to 0.04, alternatively from 0.01 to 0.04.

It will be appreciated that subscripts a and d generally refer to the MQ resinous portion of the silicone resin (B1), such that the ratio of subscript a to subscript d may be used to characterize the silicone resin (B1). For example, in some embodiments, the ratio of M siloxy units indicated by subscript a to Q siloxy units indicated by subscript d is from 0.5 to 1.5 (a:d). In these or other embodiments, the ratio of M siloxy units indicated by subscript a to Q siloxy units indicated by subscript d is from 0.7 to 1.2 (a:d).

In specific embodiments, subscripts b and c are each 0 such that the silicone resin (B1) has the average formula (R¹₃SiO_{1/2})ₓ(SiO_{4/2})_{y}, wherein each R¹ is independently selected and defined above, 0.2≤x≤0.6, 0.4≤y≤0.8, and x+y=1. In certain embodiments, 0.25≤x≤0.55, alternatively 0.3≤x≤0.55 alternatively 0.35≤x≤0.5, alternatively 0.4≤x≤0.5. In these or other embodiments, 0.45≤y≤0.75, alternatively 0.45≤y≤0.7 alternatively 0.5≤y≤0.65, alternatively 0.5≤y≤0.6.

In various embodiments, the silicone resin (B1) has a weight-average molecular weight of from 2,000 to 30,000, alternatively from 5,000 to 30,000, alternatively from 10,000 to 30,000, alternatively from 15,000 to 30,000, alternatively from 20,000 to 30,000. As understood by those of skill in the art, weight-average molecular weight may be readily determined in Daltons using triple-detector gel permeation chromatography (e.g. with light-scattering, refractive index and viscosity detectors) against a polystyrene standard. As understood in the art, the silicone resin (B1) may include at least some silicon-bonded hydroxyl (i.e., silanol) groups and/or silicon-bonded alkoxy groups attributable to hydrolysis/condensation often utilized to prepare such silicone resins. For example, the silicone resin (B1) may include from 0 to 4 wt. % silicon-bonded hydroxyl groups. Such groups may be referred to as SiOZ groups, where Z is H or an alkyl group.

As described above, the pre-mixture (B) includes a physical blowing agent (B2). The physical blowing agent (B2) is not limited so long as it is capable of at least partially solubilizing, alternatively fully solubilizing, the silicone resin (B1). In addition, the physical blowing agent (B2) imparts voids or cells to the foam formed with the composition, as described below.

In various embodiments, the physical blowing agent (B2) is one that undergoes a phase change from a liquid to a gaseous state during exposure to atmospheric pressure and a temperature≥10° C., alternatively ≥20° C., alternatively ≥30° C., alternatively ≥40° C., alternatively ≥50° C., alternatively ≥60° C., alternatively ≥70° C., alternatively ≥80° C., alternatively ≥90° C., alternatively ≥100° C. The boiling point temperature generally depends upon the particular selection of physical blowing agent (B2), which can be selected based on desired curing or foam formation parameters.

Useful physical blowing agents include hydrocarbons, such as pentane and hexane; halogenated (e.g. chlorinated and/or fluorinated) hydrocarbons, such as methylene chloride, chloroform, trichloroethane, chlorofluorocarbons, and hydrochlorofluorocarbons (“HCFCs”); ethers; and ketones and esters, such as methyl formate, ethyl formate, methyl acetate or ethyl acetate. The physical blowing agent (B2) is typically a liquid at 25° C., and the examples above are typically utilized as liquids which volatilize during foam preparation. Examples of physical blowing agents that may be gases at room temperature include air, nitrogen and/or carbon dioxide, which may also be utilized in the composition as a supplemental physical blowing agent, but which do not at least partially solubilize the silicone resin (B1). In specific embodiments, the physical blowing agent (B2) comprises or is n-pentane and/or cyclopentane. In certain embodiments, the physical blowing agent (B2) comprises a compound selected from the group consisting of propane, butane, isobutane, isobutene, isopentane, cyclopentane, n-pentane, dimethylether, or mixtures thereof. In many embodiments, the physical blowing agent (B2) is inert with respect to the components of the composition

In various embodiments, the physical blowing agent (B2) comprises a hydrofluorocarbon (“HFC”). “Hydrofluorocarbon” and “HFC” are interchangeable terms and refer to an organic compound containing hydrogen, carbon, and fluorine. HFCs are typically substantially free of halogens other than fluorine. For example, when both chorine and fluorine are present, the physical blowing agent (B2) is categorized as an HCFC not an HFC.

Examples of suitable HFCs include aliphatic compounds such as 1,1,1,3,3-pentafluoropropane (HFC-245fa), 1,1,1,3,3-pentafluorobutane (HFC-365mfc), 1-fluorobutane, nonafluorocyclopentane, perfluoro-2-methylbutane, 1-fluorohexane, perfluoro-2,3-dimethylbutane, perfluoro-1,2-dimethylcyclobutane, perfluorohexane, perfluoroisohexane, perfluorocyclohexane, perfluoroheptane, perfluoroethylcyclohexane, perfluoro-1,3-dimethyl cyclohexane, and perfluorooctane, 1,1,1,2-tetrafluoroethane (HFC-134a); as well as aromatic compounds such as fluorobenzene, 1,2-difluorobenzene; 1,4-difluorobenzene, 1,3-difluorobenzene; 1,3,5-trifluorobenzene; 1,2,4,5-tetrafluorobenzene, 1,2,3,5-tetrafluorobenzene, 1,2,3,4-tetrafluorobenzene, pentafluorobenzene, hexafluorobenzene, and 1-fluro-3-(trifluoromethyl)benzene. In certain embodiments, HFC-365mfc and HFC-245fa may be preferred due to their increasing availability and ease of use, with HFC-365mfc having a higher boiling point than HFC-245fa which may be useful in certain applications. For example, HFCs having a boiling point higher than 30° C., such as HFC-365mfc, may be desirable because they do not require liquefaction during foam processing.

An additional example of a physical blowing agent is a hydrofluoro-olefin (HFO), such as trans-1,3,3,3-tetrafluoroprop-1-ene (HFO-1234ze and/or LBA, available from Honeywell under the Solstice tradename), trans-1-chloro-3,3,3-trifluoropropene (HFO-1233zd, available from Arkema under the Forane tradename), 2,3,3,3-Tetrafluoroprop-1-ene (HFO-1234yf, available from Honeywell under the Solstice yf tradename, and Chemours under the Opteon YF tradename), cis-1,1,1,4,4,4-hexafluoro-2-butene (HFO-1336mzz-Z, available from Chemours under the Opteon MZ tradename), and Opteon 1150.

In certain embodiments, the physical blowing agent (B2) is selected from hydrocarbons and halogenated hydrocarbons. Halogenated hydrocarbons include HCFCs, HFCs and HFOs. In specific embodiments, the physical blowing agent (B2) comprises pentane (iso-pentane and/or cyclopentane), an HCFC, an HFC, and/or an HFO. In more specific embodiments, the physical blowing agent (B2) comprises pentane (iso-pentane and/or cyclopentane),

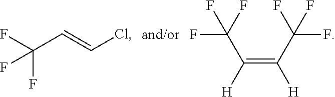 [SMILES: FC(F)(F)/C=C/Cl ; FC(F)(F)/C=C\C(F)(F)F]

The pre-mixture (B) can comprise the silicone resin (B1) and the physical blowing agent (B2) in various amounts. In certain embodiments, the pre-mixture (B) comprises the silicone resin (B1) in an amount of from greater than 0 to 50, alternatively from 2 to 48, alternatively from 4 to 46, alternatively from 6 to 44, alternatively from 8 to 42, alternatively from 10 to 40, wt. % based on the total weight of the pre-mixture (B). In these or other embodiments, the pre-mixture (B) can comprise the physical blowing agent (B2) in an amount of from 50 to less than 100, alternatively from 52 to 98, alternatively from 54 to 96, alternatively from 52 to 98, alternatively from 60 to 90, wt. %. In certain embodiments, the pre-mixture (B) consists essentially of the silicone resin (B1) and the physical blowing agent (B2). In other embodiments, the pre-mixture (B) consists of the silicone resin (B1) and the physical blowing agent (B2).

The pre-mixture (B) may be formed by combining together the silicone resin (B1) and the physical blowing agent (B2), optionally with stirring or mixing. As will be appreciated from the description herein, the physical blowing agent (B2) is capable of at least partially solubilizing, alternatively solubilizing, the silicone resin (B1), typically without reacting therewith. Typically, the silicone resin (B1) is a solid when combined with the physical blowing agent (B2). The term “solid” is used herein with reference to the silicone resin (B1) to describe such silicone resin as having a softening and/or melting point above room temperature, such that, at room temperature, the silicone resin (B1) is solid or substantially solid in the absence of any solvent or carrier. Typically, the silicone resin (B1) is in flake or powder form prior to be combing together with the physical blowing agent (B2). In another embodiment, the silicone resin (B1) can be solvated with an organic solvent or other vehicle other than the physical blowing agent (B2) (e.g. a polyether fluid), and the pre-mixture (B) can be formed via solvent exchange involving the physical blowing agent (B2).

With regard to the method components, the silicone resin (B1) may be prepared or otherwise obtained, i.e., as a prepared resin. Methods of preparing silicone resins such as the silicone resin (B1) are known in the art, with suitable precursors and starting materials commercially available from various suppliers.

The silicone resin (B1) and the physical blowing agent (B2) may be combined in any order, optionally under shear or mixing. The pre-mixture (B) may be prepared in batch, semi-batch, semi-continuous, or continuous processes, unless otherwise noted herein. Typically, once combined, the components of the pre-mixture (B) are homogenized, e.g. via mixing, which may be performed by any of the various techniques known in the art using any equipment suitable for the mixing. Examples of suitable mixing techniques generally include ultrasonication, dispersion mixing, planetary mixing, three roll milling, etc. Examples of mixing equipment include agitated batch kettles for relatively high-flowability (low dynamic viscosity) compositions, ribbon blenders, solution blenders, co-kneaders, twin-rotor mixers, Banbury-type mixers, mills, extruders, etc., which may be batch-type or continuous compounding-type equipment, and utilized alone or in combination with one or more mixers of the same or different type.

In certain embodiments, the pre-mixture (B) has a viscosity at 25° C. of less than 1,500, alternatively less than 1,000, alternatively less than 750, alternatively less than 500, alternatively less than 200, alternatively less than 100, alternatively less than 75, centipoise. Dynamic viscosity may be measured via a TA Instruments AR²⁰⁰⁰ rheometer with 45 mm cone-plate geometry at a constant shear rate of 10 s⁻¹ with temperature ramp rate of 3° C./min from 20 to 80° C. Kinematic viscosity can be measured in accordance with ASTM D445.

In certain embodiments, the composition and/or the pre-mixture (B) further comprises an aminosilicon compound. Generally, the aminosilicon compound is utilized to impart the D siloxy units indicated by subscript b′, if present, and/or the T siloxy units indicated by subscript c′, if present, in the silicone resin (B1). Use of the aminosilicon compound when preparing the silicone resin (B1) and/or the composition is optional. When utilized, some residual amount of the aminosilicon compound may be present in the composition, i.e., the aminosilicon compound may not be fully consumed in preparing the silicone resin (B1) and/or the composition. Because, the aminosilicon compound is typically utilized to prepare the silicone resin (B1) when the silicone resin (B1) includes an amino group, when present, the aminosilicon compound is typically included in the pre-mixture (B). The aminosilicon compound includes a silicon-bonded substituent comprising an amino group, which can become the substituent indicated by R′ in the silicone resin (B1), if R′ is present. Typically, the aminosilicon compound also includes silicon-bonded hydroxyl and/or hydrolysable groups, such as alkoxy groups.

In specific embodiments, the aminosilicon compound comprises, alternatively is, an aminosilane, for example an aminosilane of formula R′R²ₕSi(OR²)₃₋ₕ, where subscript h is 0 or 1, R′ is defined above, and each R² is an independently selected alkyl group having from 1 to 18, alternatively from 1 to 16, alternatively from 1 to 14, alternatively from 1 to 12, alternatively from 1 to 10, alternatively from 1 to 8, alternatively from 1 to 6, alternatively from 1 to 4, carbon atoms. In one embodiment, subscript h is 0 and the aminosilicon compound is of formula R′Si(OR²)₃. One specific example of such an aminosilane is 3-propylaminotriethoxysilane. In another embodiment, subscript h is 1 and the aminosilicon compound is of formula R′R² Si(OR²)₂. One specific example of such an aminosilane is 3-propylamino(diethoxy)methylsilane.

When the aminosilicon compound is utilized to prepare the silicone resin (B1) and is of formula R′Si(OR²)₃, at least some of the aminosilicon compound utilized generally hydrolyses and condenses to give a T siloxy unit in the silicone resin (B1) indicated by subscript c′, i.e., of formula R′SiO_{3/2}. Typically, each alkoxy group of the aminosilicon compound fully hydrolyzes and condenses to give such a T siloxy unit in the silicone resin (B1). During preparation of the silicone resin (B1), when utilized, the aminosilicon compound may give partial condensate products in a reaction intermediary of the silicone resin (B1). When the aminosilicon compound is utilized and is of formula R′Si(OR²)₃, the partial condensate products are of formula (R′(OZ)_{q}SiO_{3-q/2}), where subscript q is independently 0, 1, or 2, and each Z is independently H or R².

When the aminosilicon compound is utilized to prepare the silicone resin (B1) and is of formula R′R²Si(OR²)², at least some of the aminosilicon compound utilized generally hydrolyses and condenses to give a D siloxy unit in the silicone resin (B1) indicated by subscript b′, i.e., of formula R′R¹SiO_{2/2}. Typically, each alkoxy group of the aminosilicon compound fully hydrolyzes and condenses to give such a D siloxy unit in the silicone resin (B1). During preparation of the silicone resin (B1), when utilized, the aminosilicon compound may give partial condensate products in a reaction intermediary of the silicone resin (B1). When the aminosilicon compound is so utilized and is of formula R′R² Si(OR²)², the partial condensate products are of formula R′R² (OZ)rSiO_{2-r/2}, where subscript r is independently 0 or 1, and each Z is independently H or R².

Combinations of different aminosilicon compounds may be utilized together as the aminosilicon compound. The aminosilicon compound is typically present in the pre-mix (B) in an amount of from 0 to 25, alternatively from 0 to 20, alternatively from 0 to 15, wt. % based on the total weight of the pre-mix (B).

The composition further comprises (C) a polyisocyanate. Suitable polyisocyanates for the composition have two or more isocyanate functionalities, and include conventional aliphatic, cycloaliphatic, araliphatic and aromatic isocyanates. The polyisocyanate (C) may be selected from the group of diphenylmethane diisocyanates (“MDI”), polymeric diphenylmethane diisocyanates (“pMDI”), toluene diisocyanates (“TDI”), hexamethylene diisocyanates (“HDI”), dicyclohexylmethane diisocyanates (“HMDI”), isophorone diisocyanates (“IPDI”), cyclohexyl diisocyanates (“CHDI”), naphthalene diisocyanate (“NDI”), phenyl diisocyanate (“PDI”), and combinations thereof. In certain embodiments, the polyisocyanate (C) comprises, consists essentially of, or is a pMDI. In one embodiment, the polyisocyanate (C) is of the formula OCN—R—NCO, wherein R is an alkyl moiety, an aryl moiety, or an arylalkyl moiety. In this embodiment, the polyisocyanate (C) can include any number of carbon atoms, typically from 4 to 20 carbon atoms.

Specific examples of suitable polyisocyanates include: alkylene diisocyanates with 4 to 12 carbons in the alkylene moiety, such as 1,12-dodecane diisocyanate, 2-ethyl-1,4-tetramethylene diisocyanate, 2-methyl-1,5-pentamethylene diisocyanate, 1,4-tetramethylene diisocyanate and 1,6-hexamethylene diisocyanate; cycloaliphatic diisocyanates, such as 1,3-and 1,4-cyclohexane diisocyanate as well as any mixtures of these isomers, 1-isocyanato-3,3,5-trimethyl-5-isocyanatomethylcyclohexane, 2,4- and 2,6-hexahydrotoluene diisocyanates, as well as the corresponding isomeric mixtures, 4,4′- 2,2′-, and 2,4′-dicyclohexylmethane diisocyanate as well as the corresponding isomeric mixtures; and aromatic diisocyanates and polyisocyanates, such as 2,4- and 2,6-toluene diisocyanate and the corresponding isomeric mixtures, 4,4′-, 2,4′-, and 2,2′-diphenylmethane diisocyanate and the corresponding isomeric mixtures, mixtures of 4,4′-, 2,4′-, and 2,2-diphenylmethane diisocyanates and polyphenylenepolymethylene polyisocyanates, as well as mixtures of MDI and toluene diisocyanate (TDI).

The polyisocyanate (C) may include modified multivalent isocyanates, i.e., products obtained by the partial chemical reaction of organic diisocyanates and/or polyisocyanates. Examples of suitable modified multivalent isocyanates include diisocyanates and/or polyisocyanates containing ester groups, urea groups, biuret groups, allophanate groups, carbodiimide groups, isocyanurate groups, and/or urethane groups. Specific examples of suitable modified multivalent isocyanates include organic polyisocyanates containing urethane groups and having an NCO content of 15 to 33.6 parts by weight based on the total weight, e.g. with low molecular weight diols, triols, dialkylene glycols, trialkylene glycols, or polyoxyalkylene glycols with a molecular weight of up to 6000; modified 4,4′-diphenylmethane diisocyanate or 2,4- and 2,6-toluene diisocyanate, where examples of di-and polyoxyalkylene glycols that may be used individually or as mixtures include diethylene glycol, dipropylene glycol, polyoxyethylene glycol, polyoxypropylene glycol, polyoxyethylene glycol, polyoxypropylene glycol, and polyoxypropylene polyoxyethylene glycols or triols. Further examples of suitable polyisocyanates include prepolymers containing NCO groups with an NCO content of from 3.5 to 29 parts by weight based on the total weight of the polyisocyanate (C) and produced from the polyester polyols and/or polyether polyols; 4,4′-diphenylmethane diisocyanate, mixtures of 2,4′- and 4,4′-diphenylmethane diisocyanate, 2,4-and/or 2,6-toluene diisocyanates or polymeric MDI. Furthermore, liquid polyisocyanates containing carbodiimide groups having an NCO content of from 15 to 33.6 parts by weight based on the total weight of the polyisocyanate (C) may also be suitable, e.g. based on 4,4′-and 2,4′- and/or 2,2′-diphenylmethane diisocyanate and/or 2,4′- and/or 2,6-toluene diisocyanate. The modified polyisocyanates may optionally be mixed together or mixed with unmodified organic polyisocyanates such as 2,4′- and 4,4′-diphenylmethane diisocyanate, polymeric MDI, 2,4′- and/or 2,6-toluene diisocyanate.

It is to be appreciated that the polyisocyanate (C) may include any combination of two or more polyisocyanates that are different from one another based on functionality, molecular weight, viscosity, or structure. In specific embodiments, the polyisocyanate (C) comprises, consists essentially of, or is, a pMDI.

The polyisocyanate (C) typically has a functionality of from 2.0 to 5.0, alternatively from 2.0 to 4.5, alternatively from 2.0 to 4.0, alternatively from 2.0 to 3.5.

In these or other embodiments, the polyisocyanate (C) has an NCO by weight of from 15 to 60, alternatively from 15 to 55, alternatively from 20 to 48.5, wt. %. Methods of determining content of NCO by weight are known in the art based on functionality and molecular weight of the particular polyisocyanate.

The polyisocyanate (C) may be present in the composition in various amounts. In one embodiment, the polyisocyanate (C) and the polyol (A) are selected and present in the composition in an amount to provide an isocyanate index of at least 130, such that the composition cures to give a polyisocyanurate foam. In certain embodiments, the polyisocyanate (C) is present in the composition in an amount to provide an isocyanate index of from 130 to 700, alternatively from 130 to 600, alternatively from 130 to 550, alternatively from 130 to 500, alternatively from 130 to 450, alternatively from 130 to 400, alternatively from 150 to 350, alternatively from 180 to 350. Isocyanate index is the molar ratio of NCO to isocyanate-reactive hydrogen functional groups, times 100. Isocyanate index and methods of its calculation are well known in the art. In other embodiments, the polyisocyanate (C) and the polyol (A) are selected and present in the composition in an amount to provide an isocyanate index of less than 130, e.g. from 50 to less than 130, such that the composition cures to give a polyurethane foam. Further still, the composition can cure to give a polyisocyanurate/polyurethane hybrid foam.

The composition additionally comprises a (D) a catalyst.

In one embodiment, the catalyst (D) comprises a tin catalyst. Suitable tin catalysts include tin(II) salts of organic carboxylic acids, e.g. tin(II) acetate, tin(II) octoate, tin(II) ethylhexanoate and tin(II) laurate. In one embodiment, the catalyst (D) comprises dibutyltin dilaurate, which is a dialkyltin(IV) salt of an organic carboxylic acid. Specific examples of suitable organometallic catalyst, e.g. dibutyltin dilaurates, are commercially available from Air Products and Chemicals, Inc. of Allentown, PA, under the trademark DABCO®. The organometallic catalyst can also comprise other dialkyltin(IV) salts of organic carboxylic acids, such as dibutyltin diacetate, dibutyltin maleate and dioctyltin diacetate.

Examples of other suitable catalysts include iron(II) chloride; zinc chloride; lead octoate; tris(dialkylaminoalkyl)-s-hexahydrotriazines, including tris(N,N-dimethylaminopropyl)-s-hexahydrotriazine; tetraalkylammonium hydroxides, including tetramethylammonium hydroxide; alkali metal hydroxides, including sodium hydroxide and potassium hydroxide; alkali metal alkoxides, including sodium methoxide and potassium isopropoxide; and alkali metal salts of long-chain fatty acids having from 10 to 20 carbon atoms and/or lateral OH groups.

Further examples of other suitable catalysts, specifically trimerization catalysts, include N,N,N-dimethylaminopropylhexahydrotriazine, potassium, potassium acetate, N,N,N-trimethyl isopropyl amine/formate, and combinations thereof.

Yet further examples of other suitable catalysts, specifically tertiary amine catalysts, include dimethylaminoethanol, dimethylaminoethoxyethanol, triethylamine, N,N,N′,N′-tetramethylethylenediamine, triethylenediamine (also known as 1,4-diazabicyclo[2.2.2]octane), N,N-dimethylaminopropylamine, N,N,N′,N′,N″-pentamethyldipropylenetriamine, tris(dimethylaminopropyl)amine, N,N-dimethylpiperazine, tetramethylimino-bis(propylamine), dimethylbenzylamine, trimethylamine, triethanolamine, N,N-diethyl ethanolamine, N-methylpyrrolidone, N-methylmorpholine, N-ethylmorpholine, bis(2-dimethylamino-ethyl)ether, N,N-dimethylcyclohexylamine (“DMCHA”), N,N,N′,N′,N″-pentamethyldiethylenetriamine, 1,2-dimethylimidazole, 3-(dimethylamino) propylimidazole, 2,4,6-tris(dimethylaminomethyl) phenol, and combinations thereof. The catalyst (D) can comprise delayed action tertiary amine based on 1,8-diazabicyclo[5.4.0]undec-7-ene (“DBU”). Alternatively or in addition, the catalyst (D) can comprise N,N,N′-trimethyl-N′-hydroxyethyl-bisaminoethylether and/or ethylenediamine. The tertiary amine catalysts can be further modified for use as delayed action catalysts by addition of approximately the same stoichiometric amount of acidic proton containing acid, such as phenols or formic acid. Such delayed action catalysts are commercially available from Air Products and Evonik.

The catalyst (D) may be utilized neat or disposed in a carrier vehicle. Carrier vehicles are known in the art and further described below as an optional component for the composition. If the carrier vehicle is utilized and solubilizes the catalyst (D), the carrier vehicle may be referred to as a solvent. The carrier vehicle can be isocyanate-reactive, e.g. an alcohol-functional carrier vehicle, such as dipropylene glycol.

The catalyst (D) can be utilized in various amounts. The catalyst (D) may include any combination of different catalysts.

In certain embodiments, the composition may comprise a supplemental blowing agent in addition to the physical blowing agent (B2) of the pre-mixture (B). For example, the composition can comprise a physical blowing agent in addition to that present in the pre-mixture (B), which may be independently selected from any of the physical blowing agents described above for component (B2). Typically, however, the composition does not include any physical blowing agent separate from or in addition to that which is included in the pre-mixture (B) as component (B2). Thus, if the supplemental blowing agent is utilized, the supplemental blowing agent is typically a chemical blowing agent.

Examples of chemical blowing agents include Si-OH compounds, which may be monomers, oligomers, or polymers. In certain embodiments, the chemical blowing agent is selected from the group consisting of organosilanes and organosiloxanes having at least one silanol (Si—OH) group. Examples of suitable OH-functional compounds include dialkyl siloxanes, such as OH-terminated dimethyl siloxanes. Such siloxanes may have a relatively low viscosity, such as 10 to 5,000, 10 to 2,500, 10 to 1,000, 10 to 500, or 10 to 100, mPa·s at 25° C.

In specific embodiments, the chemical blowing agent comprises, alternatively is, water. The amount of water present in the total mass of the composition (prior to reaction) is typically from 0.02 to 1.00, alternatively from 0.03 to 0.9, alternatively from 0.05 to 0.8%, alternatively from 0.1 to 0.7, wt. % based on the total weight of the composition. Notably, at least some water may be present in the polyol (A) from its method of manufacture. When water is inherently present in component (A), the water in component (A) is not a discretely added supplemental blowing agent. In certain embodiments, water is the only supplemental blowing agent present in the composition, and the water is only present along with the polyol in component (A).

In certain embodiments, the composition is a two- or multi-component system or composition. For example, the (A) polyol is present in an isocyanate-reactive component and the (C) polyisocyanate is present in an isocyanate component separate from the isocyanate-reactive component. Typically, the pre-mixture (B) is present along with the (A) polyol in the isocyanate-reactive component. The catalyst (D) can be present in the isocyanate-reactive component, the isocyanate component, or in a further component altogether separate from both the isocyanate-reactive and isocyanate components (such that the composition is a multi-component composition). In specific embodiments, the isocyanate component consists of the polyisocyanate (C), and the remaining components are present in the isocyanate-reactive component.

In certain embodiments, the composition further comprises (E) a surfactant. The surfactant (E) may be present in the isocyanate-reactive component, the isocyanate component, or a component separate from the isocyanate-reactive and isocyanate components. Suitable surfactants (or “foaming aids”) include silicone polyethers, ethylene oxide polymers, propylene oxide polymers, copolymers of ethylene oxide and propylene oxide, other non-ionic surfactants, and combinations thereof. When the composition comprises a silicone polyether as a surfactant, the surfactant is distinguished from the silicone resin (B1), which is not a surfactant, as understood in the art. Typically, such silicone polyether surfactants are non-resinous. Further suitable surfactants may comprise a nonionic surfactant, a cationic surfactant, an anionic surfactant, an amphoteric surfactant, or a mixture of such surfactants.

In various embodiments, the composition comprises a fluorocarbon surfactant or fluorinated surfactant. The fluorinated surfactants can be any of those compounds known in the art which contain fluorine atoms on carbon and are also surfactants. These fluorinated surfactants can be organic or silicon containing. For example, fluorinated organic surfactants can be perfluorinated polyethers such as those which have repeating units of the formulae:

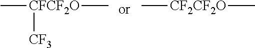

and mixtures of such units.

Silicon-containing fluorinated surfactants can be siloxanes, for example, which contain organic radicals having fluorine bonded thereto, such as siloxanes having repeating units of the formulae:

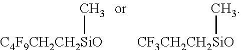

In various embodiments, adding the fluorinated surfactant to the composition decreases a density of the foam. In general, increasing the amount of fluorinated surfactant in the composition decreases the density of the foam. This is especially true for slow cure systems, where the surfactant stabilizes bubbles while the network forms and cures.

The surfactant (E) can be utilized in various amounts, typically from greater than 0 to 5, alternatively from greater than 0 to 4, alternatively from greater than 0 to 3, alternatively from greater than 0 to 2, weight percent based on the total weight of the composition.

The composition may optionally further include an additive component. The additive component may be selected from the group of carrier vehicles, catalysts, blowing agents, plasticizers, cross-linking agents, chain-extending agents, chain-terminating agents, wetting agents, surface modifiers, waxes, foam stabilizing agents, moisture scavengers, desiccants, viscosity reducers, cell-size reducing compounds, reinforcing agents, dyes, pigments, colorants, fillers, flame retardants, mold release agents, anti-oxidants, compatibility agents, ultraviolet light stabilizers, thixotropic agents, anti-aging agents, lubricants, coupling agents, solvents, rheology promoters, adhesion promoters, thickeners, smoke suppressants, anti-static agents, anti-microbial agents, functionalized silanes, nucleators, and combinations thereof.

One or more of the additives can be present as any suitable weight percent (wt. %) of the composition, such as 0.1 wt. % to 15 wt. %, 0.5 wt. % to 5 wt. %, or 0.1 wt. % or less, 1 wt. %, 2, 3, 4, 5, 6, 7, 8, 9, 10, 11, 12, 13, 14, or 15 wt. % or more of the composition. One of skill in the art can readily determine a suitable amount of additive depending, for example, on the type of additive and the desired outcome. Certain optional additives are described in greater detail below.

Suitable carrier vehicles include silicones, both linear and cyclic, organic oils, organic solvents and mixtures of these.

The carrier vehicle may also be a low viscosity organopolysiloxane or a volatile methyl siloxane or a volatile ethyl siloxane or a volatile methyl ethyl siloxane having a viscosity at 25° C. in the range of 1 to 1,000 mm²/sec, such as hexamethylcyclotrisiloxane, octamethylcyclotetrasiloxane, decamethylcyclopentasiloxane, dodecamethylcyclohexasiloxane, octamethyltrisiloxane, decamethyltetrasiloxane, dodecamethylpentasiloxane, tetradecamethylhexasiloxane, heptamethyl-3-{(trimethylsilyl)oxy)}trisiloxane, hexamethyl-3,3,bis{(trimethylsilyl)oxy}trisiloxane pentamethyl{(trimethylsilyl)oxy}cyclotrisiloxane as well as polydimethylsiloxanes, polyethylsiloxanes, polymethylethylsiloxanes, polymethylphenylsiloxanes, polydiphenylsiloxanes, caprylyl methicone, and any mixtures thereof.

In certain embodiments, the carrier vehicle comprises an organic fluid, which typically comprises an organic oil including a volatile and/or semi-volatile hydrocarbon, ester, and/or ether. General examples of such organic fluids include volatile hydrocarbon oils, such as C₆-C₁₆ alkanes, C₈-C₁₆ isoalkanes (e.g. isodecane, isododecane, isohexadecane, etc.), C₈-C₁₆ branched esters (e.g. isohexyl neopentanoate, isodecyl neopentanoate, etc.), and the like, as well as derivatives, modifications, and combinations thereof. Additional examples of suitable organic fluids include aromatic hydrocarbons, aliphatic hydrocarbons, alcohols having more than 3 carbon atoms, aldehydes, ketones, amines, esters, ethers, glycols, glycol ethers, alkyl halides, aromatic halides, and combinations thereof. Hydrocarbons include isododecane, isohexadecane, Isopar L (C₁₁-C₁₃), Isopar H (C₁₁-C₁₂), hydrogentated polydecene. Ethers and esters include isodecyl neopentanoate, neopentylglycol heptanoate, glycol distearate, dicaprylyl carbonate, diethylhexyl carbonate, propylene glycol n-butyl ether, ethyl-3 ethoxypropionate, propylene glycol methyl ether acetate, tridecyl neopentanoate, propylene glycol methylether acetate (PGMEA), propylene glycol methyl ether (PGME), octyldodecyl neopentanoate, diisobutyl adipate, diisopropyl adipate, propylene glycol dicaprylate/dicaprate, octyl ether, octyl palmitate, and combinations thereof.

In some embodiments, the carrier vehicle comprises an organic solvent. Examples of organic solvents include those comprising an alcohol, such as methanol, ethanol, isopropanol, butanol, and n-propanol; a ketone, such as acetone, methylethyl ketone, and methyl isobutyl ketone; an aromatic hydrocarbon, such as benzene, toluene, and xylene; an aliphatic hydrocarbon, such as heptane, hexane, and octane; a halogenated hydrocarbon, such as dichloromethane, 1,1,1-trichloroethane, and chloroform; dimethyl sulfoxide; dimethyl formamide, acetonitrile; tetrahydrofuran; white spirits; mineral spirits; naphtha; n-methylpyrrolidone; and the like, as well as derivatives, modifications, and combination thereof. In certain embodiments, the carrier vehicle comprises a polar organic solvent, such as a solvent compatible with water. Specific examples of such polar organic solvents utilized in certain embodiments include methanol, ethanol, 1-propanol, 2-propanol, 2-methyl-2-propanol, 2-butanone, tetrahydrofuran, acetone, and combinations thereof. Other carrier vehicles may also be utilized in place of, in addition to, or in combination with, those described herein. In certain embodiments, the carrier vehicle comprises, alternatively is, an aliphatic and/or aromatic hydrocarbon solvent such as xylene, etc., a siloxane solvent such as hexamethylene disiloxane (HMDSO), D4 or D5 cyclics or other such siloxanes, or a combination thereof. In other embodiments, the composition is substantially free from certain solvents. For example, in some embodiments, the composition is free from, alternatively substantially free from, hexamethylene disiloxane (HMDSO), D4 cyclics, and/or D5 cyclics. In these or other embodiments, the composition is free from, alternatively substantially free from benzene, toluene, ethylbenzene, and xylenes (i.e., BTEX solvents). In these or other embodiments, the composition is free from, alternatively substantially free from aromatic solvents. In certain embodiments, the only component that can be categorized as an organic solvent or carrier vehicle present in the composition is the physical blowing agent (B2).

Suitable pigments are understood in the art. In various embodiments, the composition further comprises carbon black, e.g. acetylene black.

The composition may include one or more fillers. The fillers may be one or more reinforcing fillers, non-reinforcing fillers, or mixtures thereof. Examples of finely divided, reinforcing fillers include high surface area fumed and precipitated silicas including rice hull ash and to a degree calcium carbonate. Fumed silica can include types that are surface-functionalized, such as hydrophilic or hydrophobic, and are available from Cabot Corporation under the CAB-O-SIL tradename. Examples of finely divided non-reinforcing fillers include crushed quartz, diatomaceous earths, barium sulphate, iron oxide, titanium dioxide and carbon black, talc, and wollastonite. Other fillers which might be used alone or in addition to the above include carbon nanotubes, e.g. multiwall carbon nanotubes aluminite, hollow glass spheres, calcium sulphate (anhydrite), gypsum, calcium sulphate, magnesium carbonate, clays such as kaolin, aluminum trihydroxide, magnesium hydroxide (brucite), graphite, copper carbonate, e.g. malachite, nickel carbonate, e.g. zarachite, barium carbonate, e.g. witherite and/or strontium carbonate e.g. strontianite. Further alternative fillers include aluminum oxide, silicates from the group consisting of olivine group; garnet group; aluminosilicates; ring silicates; chain silicates; and sheet silicates. In certain embodiments, the composition includes at least one filler comprising hollow particles, e.g. hollow spheres. Such fillers can be useful for contributing to porosity and/or overall void fraction of the foam. Fillers, when utilized, can be used in the composition in amounts of from 0.01 to 50, alternatively from 0.05 to 40, alternatively from 0.1 to 35, wt. %based on the total weight of the composition. In addition, fumed silica, if utilized, can be used in amounts from 0.01 to 5, alternatively from 0.05 to 3, alternatively from 0.1 to 2.5, alternatively from 0.2 to 2.2 wt. % based on the total weight of the composition.

The filler, if present, may optionally be surface treated with a treating agent. Treating agents and treating methods are understood in the art. The surface treatment of the filler(s) is typically performed, for example with a fatty acid or a fatty acid ester such as a stearate, or with organosilanes, organosiloxanes, or organosilazanes such as hexaalkyl disilazane or short chain siloxane diols. Generally, the surface treatment renders the filler(s) hydrophobic and therefore easier to handle and obtain a homogeneous mixture with the other components in the composition. Silanes such as R⁴ₑSi(OR⁵)₄₋ₑ where R⁴ is a substituted or unsubstituted monovalent hydrocarbon group of 6 to 20 carbon atoms, for example, alkyl groups such as hexyl, octyl, dodecyl, tetradecyl, hexadecyl, and octadecyl, and aralkyl groups such as benzyl and phenylethyl, R⁵ is an alkyl group of 1 to 6 carbon atoms, and subscript “e” is equal to 1, 2 or 3, may also be utilized as the treating agent for fillers.

In various embodiments, the composition further comprises an adhesion-imparting agent. The adhesion-imparting agent can improve adhesion of the foam to a base material being contacted during curing. The adhesion-imparting agent can be a functionalized silane. For example, in certain embodiments, the adhesion-imparting agent includes at least one silicon-bonded functional group selected from alkoxy groups, ester groups, amino groups (primary, secondary, or tertiary amino groups), hydroxyl groups, isocyanate groups, thiol groups, epoxy groups, and methacryloxy groups. In these or other embodiments, the functionalized silane includes at least one silicon-bonded alkoxy group at least one functional group selected from amino groups (primary, secondary, or tertiary amino groups), hydroxyl groups, isocyanate groups, thiol groups, epoxy groups, and methacryloxy groups.

In certain embodiments, the adhesion-imparting agent is selected from organosilicon compounds having at least one alkoxy group bonded to a silicon atom in a molecule. This alkoxy group is exemplified by a methoxy group, an ethoxy group, a propoxy group, a butoxy group, and a methoxyethoxy group. Moreover, non-alkoxy groups bonded to a silicon atom of this organosilicon compound are exemplified by substituted or non-substituted monovalent hydrocarbon groups such as alkyl groups, alkenyl groups, aryl groups, aralkyl groups, halogenated alkyl groups and the like; epoxy group-containing monovalent organic groups such as a 3-glycidoxypropyl group, a 4-glycidoxybutyl group, or similar glycidoxyalkyl groups; a 2-(3,4-epoxycyclohexyl)ethyl group, a 3-(3,4-epoxycyclohexyl)propyl group, or similar epoxycyclohexylalkyl groups; and a 4-oxiranylbutyl group, an 8-oxiranyloctyl group, or similar oxiranylalkyl groups; acrylic group-containing monovalent organic groups such as a 3-methacryloxypropyl group and the like; and a hydrogen atom.

This organosilicon compound generally has a silicon-bonded alkenyl group or silicon-bonded hydrogen atom. Moreover, due to the ability to impart good adhesion with respect to various types of base materials, this organosilicon compound generally has at least one epoxy group-containing monovalent organic group in a molecule. This type of organosilicon compound is exemplified by organosilane compounds, organosiloxane oligomers and alkyl silicates. Molecular structure of the organosiloxane oligomer or alkyl silicate is exemplified by a linear chain structure, partially branched linear chain structure, branched chain structure, ring-shaped structure, and net-shaped structure. A linear chain structure, branched chain structure, and net-shaped structure are typical. This type of organosilicon compound is exemplified by silane compounds such as 3-glycidoxypropyltrimethoxysilane, 2-(3,4-epoxycyclohexyl)-ethyltrimethoxysilane, 3-methacryloxy propyltrimethoxysilane, and the like; siloxane compounds having at least one silicon-bonded alkenyl group or silicon-bonded hydrogen atom, and at least one silicon-bonded alkoxy group in a molecule; mixtures of a silane compound or siloxane compound having at least one silicon-bonded alkoxy group and a siloxane compound having at least one silicon-bonded hydroxyl group and at least one silicon-bonded alkenyl group in the molecule; and methyl polysilicate, ethyl polysilicate, and epoxy group-containing ethyl polysilicate.

Examples of suitable aminofunctional alkoxysilanes suitable for use in or as the adhesion-imparting agent are exemplified by H₂N(CH₂)₂Si(OCH₃)₃, H₂N(CH₂)₂Si(OCH₂CH₃)₃, H₂N(CH₂)₃Si(OCH₃)₃, H₂N(CH₂)₃Si(OCH₂CH₃)₃, CH₃NH(CH₂)₃Si(OCH₃)₃, CH₃NH(CH₂)₃Si(OCH₂CH₃)₃, CH₃NH(CH₂)₅Si(OCH₃)₃, CH₃NH(CH₂)₅Si(OCH₂CH₃)₃, H₂N(CH₂)₂NH(CH₂)₃Si(OCH₃)₃, H₂N(CH₂)₂NH(CH₂)₃Si(OCH₂CH₃)₃, CH₃NH(CH₂)₂NH(CH₂)₃Si(OCH₃)₃, CH₃NH(CH₂)₂NH(CH₂)₃Si(OCH₂CH₃)₃, C₄H₉NH(CH₂)₂NH(CH₂)₃Si(OCH₃)₃, C₄H₉NH(CH₂)₂NH(CH₂)₃Si(OCH₂CH₃)₃, H₂N(CH₂)₂SiCH₃(OCH₃)₂, H₂N(CH₂)₂SiCH₃(OCH₂CH₃)₂, H₂N(CH₂)₃SiCH₃(OCH₃)₂, H₂N(CH₂)₃SiCH₃(OCH₂CH₃)₂, CH₃NH(CH₂)₃SiCH₃(OCH₃)₂, CH₃NH(CH₂)₃SiCH₃(OCH₂CH₃)₂, CH₃NH(CH₂)₅SiCH₃(OCH₃)₂, CH₃NH(CH₂)₅SiCH₃(OCH₂CH₃)₂, H₂N(CH₂)₂NH(CH₂)₃SiCH₃(OCH₃)₂, H₂N(CH₂)₂NH(CH₂)₃SiCH₃(OCH₂CH₃)₂, CH₃NH(CH₂)₂NH(CH₂)₃SiCH₃(OCH₃)₂, CH₃NH(CH₂)₂NH(CH₂)₃SiCH₃(OCH₂CH₃)₂, C₄H₉NH(CH₂)₂NH(CH₂)₃SiCH₃(OCH₃)₂, C₄H₉NH(CH₂)₂NH(CH₂)₃SiCH₃(OCH₂CH₃)₂, and combinations thereof.

In specific embodiments, the composition, and in particular, the isocyanate-reactive component, can further comprise a chain-extending agent. Suitable chain extending agents include any of the components listed above as initiators for the polyol (A), which may be used alone or in combination as the chain-extending agent, when present, separate from and in addition to the polyol (A).

In specific embodiments, the composition further comprises a nucleator. Nucleators contribute to void formation in the foam and are believed to provide sites where the physical blowing agent (B2) had nucleate heterogeneously when transforming from a liquid to a gas. Specific examples thereof include cyclic siloxanes, such as hexamethylcyclotrisiloxane, octamethylcyclotetrasiloxane, decamethylcyclopentasiloxane, dodecamethylcyclohexasiloxane, octamethyltrisiloxane, decamethyltetrasiloxane, and dodecamethylpentasiloxane, tetradecamethylhexasiloxane; and siloxanes having a degree of polymerization (DP) of from 2 to 10, e.g. PDMS oligomers or polymers.

Any of the optional additives, if utilized in the composition, may be present in the isocyanate-reactive component or as a separate component in the composition. Alternatively, optional additives that are not isocyanate-reactive, e.g. fillers, etc., may be included in the isocyanate component. Typically, the composition is a 2k (two-component) composition, where the isocyanate component consists of the polyisocyanate (C) and the isocyanate-reactive component comprises the components other than the polyisocyanate (C).

In certain embodiments, the isocyanate-reactive component has a viscosity at 25° C. of >0 and less than 3,500, alternatively less than 3,000, alternatively less than 2500, alternatively less than 2000, alternatively less than 1500, alternatively less than 1000, alternatively less than 500, centipoise. Dynamic viscosity may be measured via a TA Instruments AR²⁰⁰⁰ rheometer with 45 mm cone-plate geometry at a constant shear rate of 10 s⁻¹ with temperature ramp rate of 3° C./min from 20 to 80° C. Kinematic viscosity can be measured in accordance with ASTM D445. These ranges apply even when the composition is a 2k composition and the isocyanate-reactive component includes everything in the composition other than the polyisocyanate (C).

As introduced above, a method of preparing the composition comprises contacting the silicone resin (B1) and the physical blowing agent (B2) to give the pre-mixture (B); and combining the pre-mixture (B) with components (A), (C), and (D) to give the composition. Further, the pre-mixture (B) is typically combined with component (A) to give an isocyanate-reactive component separate from the polyisocyanate (C). As described above, the pre-mixture (B) is formed prior to forming the composition. Said differently, the pre-mixture (B) is not formed in situ by combining components (B1) and (B2) along with the other components in forming the composition. Instead, it is the pre-mixture (B) itself that is combined with the other components to give the composition. Surprisingly, it has been found that use of the pre-mixture (B), rather than use of components (B1) and (B2) in the absence of the pre-mixture (B), impacts properties in the resulting foam.

Further, as described above, the aminosilicon compound may optionally be utilized in the method. When utilized, the aminosilicon compound can be incorporated at any time of the method of preparing the composition. For example, in one embodiment, the silicone resin (B1) is a reaction product of the aminosilicon compound and an initial silicone resin, e.g. an MQ resin. The initial silicone resin can have the formula given above for the silicone resin (B1), but where subscripts b′ and c′ are each 0. Typically, combining the initial silicone resin and the aminosilicon compound results in hydrolysis and condensation between the SiOZ groups inherently present in the initial silicone resin and hydrolysable groups in the aminosilicon compound. No condensation catalyst is necessary to prepare the silicone resin (B1) with the aminosilicon compound, but such a catalyst may optionally be utilized. When the aminosilicon compound is utilized, it is typically combined with the initial silicone resin to give the silicone resin (B1) prior to combining the silicone resin (B1) and the physical blowing agent (B2) to give the pre-mixture (B). In other embodiments, the silicone resin (B1) is formed in situ in the physical blowing agent (B2) to give the pre-mixture (B).

The composition may be prepared by combining the isocyanate-reactive component and the isocyanate component, as well as any optional components, if not present in the isocyanate-reactive component, in any order of addition. As described above, the composition may be a one part composition, a two component or 2K composition, or a multi-part composition. When the isocyanate-reactive component and the isocyanate component are combined, particularly in the presence of the catalyst (D), a reaction is initiated, which results in a foam. The foam can be formed at room temperature and ambient conditions. Alternatively, at least one condition may be selectively modified during formation of the foam, e.g. temperature, humidity, pressure, etc.

The foam comprising the reaction product of the composition is also disclosed.

In many embodiments, the foam is a closed-cell foam. In other embodiments, the foam is an open-celled foam. In various embodiments, the foam has a density from 30 to 70, alternatively from 30 to 60, alternatively from 35 to 55, alternatively from 40 to 55, kg/m³. Density of the foam can be determined via methods understood in the art. For example, density of the foam can be measured via the Archimedes principle, using a balance and density kit, and following standard instructions associated with such balances and kits. An example of a suitable balance is a Mettler-Toledo XS205DU balance with density kit.

In various embodiments, the foam has pores that are generally uniform in size and/or shape and/or distribution. In certain embodiments, the foam has an average pore size≤5 millimeters, alternatively ≤2.5 millimeters, alternatively ≤1 millimeter, alternatively ≤0.75 millimeters, alternatively from 0.1 to 0.7 millimeters, alternatively from 0.2 to 0.6 millimeters.

Average pore size can be determined via methods understood in the art. For example, ATSM method D3576-15 with the following modifications may be used: (1) image a foam using optical or electron microscopy rather than projecting the image on a screen; and (2) scribe a line of known length that spans greater than 15 cells rather than scribing a 30 mm line.

In various embodiments, the foam has a k-factor of from 15 to 28 mW/m·K. As understood in the art, k-factor can be measured in accordance with ASTM C 518 and as described below in connection with the examples.

The foam, as well as a composite article comprising a substrate and the foam together, can be formed by disposing the composition on a substrate, and curing the composition.

The composition may be disposed or dispensed on the substrate in any suitable manner. Typically, the composition is applied in wet form via a wet coating technique. The curable composition may be applied by i) spin coating; ii) brush coating; iii) drop coating; iv) spray coating; v) dip coating; vi) roll coating; vii) flow coating; viii) slot coating; ix) gravure coating; x) Meyer bar coating; or xi) a combination of any two or more of i) to x).

The substrate is not limited and may be any substrate, e.g. a mold, a sheet, a panel, etc. The foam may be separable from the substrate, e.g. if the substrate is a mold, or may be physically and/or chemically bonded to the substrate depending on its selection. The substrate may optionally have a continuous or non-continuous shape, size, dimension, surface roughness, and other characteristics.

Alternatively, the substrate may comprise a plastic, which maybe a thermosetting and/or thermoplastic. However, the substrate may alternatively be or comprise glass, ceramic, metals such as titanium, magnesium, aluminum, carbon steel, stainless steel, nickel coated steel or alloys of such metal or metals, or a combination of different materials. Because the composition can cure at ambient conditions, elevated temperatures are not required to effect curing, which can damage certain substrates.

Specific examples of suitable substrates include polymeric substrates such polyamides (PA); polyesters such as polyethylene terephthalates (PET), polybutylene terephthalates (PET), polytrimethylene terephthalates (PTT), polyethylene naphthalates (PEN), and liquid crystalline polyesters; polyolefins such as polyethylenes (PE), ethylene/acidic monomer copolymers such as is available from Dow under the tradename Surlyn, polypropylenes (PP), and polybutylenes; polystyrene (PS) and other styrenic resins such as SB rubber; polyoxymethylenes (POM); polycarbonates (PC); polymethylenemethacrylates (PMMA); polyvinyl chlorides (PVC); polyphenylene sulfides (PPS); polyphenylene ethers (PPE); polyimides (PI); polyamideimides (PAI); polyetherimides (PEI); polysulfones (PSU); polyethersulfones; polyketones (PK); polyetherketones; polyvinyl alcohols (PVA); polyetheretherketones (PEEK); polyetherketoneketones (PEKK); polyarylates (PAR); polyethernitriles (PEN); phenolic resins; phenoxy resins; celluloses such as triacetylcellulose, diacetylcellulose, and cellophane; fluorinated resins, such as polytetrafluoroethylenes; thermoplastic elastomers, such as polystyrene types, polyolefin types, polyurethane types, polyester types, polyamide types, polybutadiene types, polyisoprene types, and fluoro types; and copolymers, and combinations thereof. Thermosetting resins can include epoxy, polyurethane, polyurea, phenol-formaldehyde, urea-formaldehyde, or combinations thereof. The substrate can include a coating, film, or layer disposed thereon. Coatings made from polymer latex can be used, such as latex from acrylic acid, acrylate, methacrylate, methacrylic acid, other alkylacrylate, other alkylacrylic acid, styrene, isoprene butylene monomers, or latex from the alkyl esters of the acid monomers mentioned in the foregoing, or latex from copolymers of the foregoing monomers. Composites based on any of these resins can be used as substrates by combining with glass fibers, carbon fibers, or solid fillers such as calcium carbonate, clay, aluminum hydroxide, aluminum oxide, silicon dioxide, glass spheres, sawdust, wood fiber, or combinations thereof.

In one specific embodiment, the foam can be utilized in insulation applications, e.g. in commercial or residential insulation, insulated metal panels for roofing applications, construction-structural insulated panels (SIP), e.g. for post and beam construction, or tank and/or pipe insulation. Alternatively, in another specific embodiment, the foam can be used in sheathing applications. In addition, the foam can be utilized in appliance applications, e.g. in ovens, stoves, refrigerators, freezers, etc. in residential, commercial, or transportation industries. The end use applications of the foam are not so limited, and the foam can be utilized in lieu of any conventional rigid foam. Further still, the foam can be utilized in lieu of any conventional flexible foam. The foam is not limited to any specific density or physical property.

The following examples, illustrating embodiments of this disclosure, are intended to illustrate and not to limit the invention. Unless otherwise noted, all reactions are carried out under air, and all components are purchased or otherwise obtained from various commercial suppliers.

The following equipment and characterization procedures/parameters are used to evaluate various physical properties of the compounds and compositions prepared in the examples below.

### Equipment and Characterization Parameters

The following equipment and characterization procedures/parameters were used to evaluate various physical properties of the compositions and foams prepared in the examples below.

### Gel Permeation & Size Exclusion Chromatography (GPC/SEC)

### SEC Instrumentation

SEC is performed on a Waters 2695 LC pump and autosampler with a flow rate set at 1 mL/min, and an injection volume set at 100 μL. SEC separation is carried out on 2 Agilent PIgel Mixed-D columns using a Shodex RI-201 differential refractive index detector, each held at 35° C.

### Sample Preparation

Samples are prepared in THF eluent to a concentration ˜5 mg/mL polymer/resin. The solution is shaken on a flat-bed shaker at ambient temperature for about 2 hours, and then filtered through a 0.45 um PTFE syringe filter prior to injection.

### Processing of Data

Agilent GPC software Cirrus version 3.3 is used for data collection and for data reduction. A total of 16 polystyrene (PS) linear narrow molecular weight standards from Agilent, having Mp values from 3752 to 0.58 kg/mol, are used for molecular weight calibration. A 3^{rd} order polynomial is used for calibration curve fitting, and all molecular weight averages, distributions, and references to molecular weight are provided as PS equivalent values.

### ²⁹Si NMR

For ²⁹Si NMR, 2.5 to 3 g of each product prepared below and about 5 g of solvent (CDCl₃+Cr(acac)₃) were loaded into a 16 mm silicon free NMR tube and the spectra were obtained as per conditions and instrumentation in Table 2 below:

TABLE 2
²⁹Si NMR Instrumentation

| Parameter: | ²⁹Si | |
|---|---|---|
| Instrument | Agilent 500 DD2 NMR Spectrometer | |
| NMR Probe | 16 mm Si Free AutoX Probe | |
| Spectrometer Field Strength | 11.7 T | |
| Pulse Sequence | S2PUL | |
| Number scans (nt): | 64 | |
| Acquisition Time (at): | 1.0161 | s |
| Delay Time (d1): | 13 | s |
| Pulse Width (pw) | 18 | μs |
| Solvent | CDCl3 + Cr(acac)3 | |
| Decoupler modulation (dm) | nny | |
| Decoupler offset frequency (dof) | −400 | hz |
| Decoupler modulation field (dmf) | 8812 | hz |
| Decoupler sequence (dseq) | Waltz16 | |
| Transmitter offset frequency (tof) | −5006 | hz |

Foam density was measured via a modified ASTM D 1622. For this purpose, a 5×5×5 cm cube was cut from each foam formed in a cubic box (i.e., each free rise foam as described below).

Cream time (CT), gel time (GT), and tack free time were measured visually by placing each 80 g of each composition below foamed in a cup mixed at 2,800 revolutions per minute (rpm).

Thermal conductivity of the foams was measured in accordance with ASTM C 518, measuring lambda value (k-factor) at average of 12.5° C. (25° C. top, 0° C. bottom plate) using a TA LaserComp Fox 200 instrument. Samples having dimensions of 20×20×2.5 cm of each foam were obtained with a band saw for measuring k-factor/thermal conductivity.

Limited Oxygen Index (LOI) was measured on FTT Oxygen Index (Model number FTT0077) from Fire Testing Technology (FTT), which determines the minimum percentage of oxygen in the test atmosphere which was required to marginally support combustion in accordance with ISO 4589 Part 3 or the UK Naval Engineering Standard NES 715 or GB/T 2406, GB/T 5454. The LOI is a common index for determining flammability of different materials. LOI is defined as the lowest oxygen concentration (which is tuned by an oxygen-nitrogen mixture) required to sustain combustion of a vertically mounted test piece. Lower LOI indicates worse flame retardancy.

Each test piece was cut from the same position of mold foams, with dimensions of 15×1.0×1.0 cm and marked upside and downside relative to the foaming direction. The sample was put into the test area of the equipment. The nitrogen level was controlled to tune the oxygen level. Generally, 2-3 test pieces were initially burned to roughly estimate the range of LOI (the lower limit and upper limit). Starting from the lower limit of oxygen level, the test pieces were burned, and the burning behavior was monitored, using the standard of burning height of test pieces in the range, lower or higher than 5 cm under fixed oxygen level. The oxygen level was tuned up or down by 0.1-0.2% each time to find the maximum oxygen level which can burn test pieces close to but no more than 5 cm.

Maximum Smoke Density (MSD) was measured on a smoke density test equipment from ShineRay (JCY-2) according to GB/T8627-2007. Each test piece was cut from the same position of mold foams (dimensions of 2.5×2.5×2.5 cm) and marked upside and downside relative to the foaming direction. The sample was put into the test area of the equipment. The lighter was turned on and flame was tuned to the desired height. Then, the test piece was burned under the flame and the curve of smoke density and time were monitored to get a curve of smoke density versus time. MSD can be read from the curve. After the test, the chamber was cleaned, and the second test piece was tested following the same procedure. The test was repeated on 3-5 test pieces, and the average of the MSD was reported.

Average fire propagation or ignitability was measured according to Standard EN 11925-2. Each test piece was cut from the same position of mold foams (size of 9.0×19.0×25.0 cm). Each test piece was conditioned for one week prior to testing, and were hung via a test piece holder in a cabinet for analysis. A burner was positioned vertically to set a flame height to 20 mm, and the burner was tilted to a 45° angle. The flame was applied to each test piece for 15 seconds (at the bottom edge of each test piece at the center of its width and thickness), after which the burner was removed. The height of the flame was recorded. This test was repeated on 3-5 test pieces for each foam, and the maximum value measured is reported.

### Materials

A brief summary is provided in Table 1 below, setting forth information as to certain abbreviations, shorthand notations, and components utilized in the Examples.

TABLE 1
Materials Utilized

| Material Ref. | Description |
|---|---|
| Organopolysiloxane | MQ resin [M_{0.78}Q] having a molecular weight (Mw) of about |
| Resin 1 | 23,200 and an OH content of about 2.9 wt. % |
| Organopolysiloxane | MM^{VI}Q resin, having a total M (M + M^{VI}) to Q siloxy unit molar |
| Resin 2 | ratio of about 0.85, a Mw of about 23,500, a solids content of |
| | 72.5 wt. %, a Vi content of about 5 mol % (based on all silicon- |
| | bonded hydrocarbyl groups), and an OH content of about 1.8 |
| | wt. % |
| Organopolysiloxane | MQ resin [M_{0.96}Q] having a Mw that is slightly higher than |
| Resin 3 | that of Organopolysiloxane Resin 1, and an OH content of |
| | about 1.1 wt. % |
| Organopolysiloxane | Silicone resin of formula D_{0.66}T^{Ph}_{0.34} and having a |
| Resin 4 | molecular weight of about 1,100 |
| Organopolysiloxane | Silicone resin of formula D_{0.33}T^{Ph}_{0.67} and having a |
| Resin 5 | molecular weight of about 1,100 |
| Organopolysiloxane | Silicone resin of formula D_{0.15}T^{Me}_{0.83}T^{Octyl}_{0.02} and |
| Resin 6 | having a molecular weight of about 3,950 |
| Organopolysiloxane | Silicone resin of formula T^{Me}_{1.0} and having a molecular |
| Resin 7 | weight of about 378 |
| M | [(CH₃)₃SiO_{1/2}] |
| M^{Vi} | [(CH₃)₂(CH₂═CH)SiO_{1/2}] |
| D | [(CH₃)₂SiO_{2/2}] |
| T^{Ph} | [(Ph)SiO_{3/2}] |
| T^{Me} | [(CH₃)SiO_{3/2}] |
| T^{Octyl} | [(C₈H₁₇)SiO_{3/2}] |
| Q | SiO_{4/2} |
| Vi | Vinyl (—CH═CH₂) |
| Ph | Phenyl |
| Aminosilicon Compound | 3-aminopropyltriethoxysilane |
| Polyol 1 | A modified phthalic anhydride-based aromatic polyester |
| | polyol having a hydroxyl number of 220 mg KOH/g (as |
| | measured in accordance with ASTM D4274), an equivalent |
| | weight of 255, and a viscosity at 25° C. of 2,000 cP |
| Polyol 2 | A modified phthalic anhydride-based aromatic polyester |
| | polyol having a hydroxyl number of 230-250 mg KOH/g (as |
| | measured in accordance with ASTM D4274), an equivalent |
| | weight of 234, and a viscosity at 25° C. of 2,000 to 4,500 cP |
| Polyol 3 | A modified phthalic anhydride-based aromatic polyester |
| | polyol having a hydroxyl number of 230-250 mg KOH/g (as |
| | measured in accordance with ASTM D4274), an equivalent |
| | weight of 234, and a viscosity at 25° C. of 2,000 to 4,500 cP |
| Polyol 4 | Polyester polyol derived from terephthalic acid and >/= 50 |
| | mol % ortho-phthalic acid having a hydroxyl number of 315 mg |
| | KOH/g (as measured in accordance with ASTM D4274), a |
| | nominal functionality of 2.4 and <20 mol % branched glycol |
| Polyol 5 | A polyester polyol derived from terephtalic acid, diethylene |
| | glycol and polyethylene glycol, having a functionality of 2 and |
| | a hydroxyl number of 220 mg KOH/g (as measured in |
| | accordance with ASTM D4274) |
| Flame Retardant 1 | Tris(1-chloro-2-propyl) phosphate 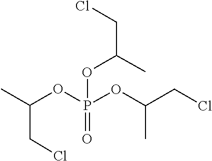 [SMILES: CC(CCl)OP(=O)(OC(C)CCl)OC(C)CCl] |
| Flame Retardant 2 | Triethyl phosphate (TEP) |
| Silicone Surfactant 1 | A linear silicone polyether surfactant having pendent |
| | polyether functionality (EO~11.2) and a Mw of about 2,350 |
| Silicone Surfactant 2 | A linear silicone polyether surfactant having pendent |
| | polyether functionality (EO/PO~10/4) and a Mw of about |
| | 8360 |
| Silicone Surfactant 3 | A linear silicone polyether surfactant having pendent |
| | polyether functionality (EO/PO~12/3) and a Mw of about |
| | 9,968 |
| Catalyst 1 | N,N,N′,N″,N″- |
| | pentamethyldiethylenetriamine/pentamethyldiethylenetriamine |
| Catalyst 2 | A solution of potassium acetate in diethylene glycol |
| Blowing Agent 1 | Water |
| Blowing Agent 2 | Cyclopentane |
| Blowing Agent 3 | Isopentane |
| Blowing Agent 4 | 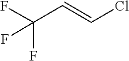 |
| Blowing Agent 5 | 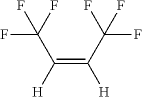 |
| Blowing Agent 6 | 70/30 blend of Blowing Agent 2 and Blowing Agent 3 |
| Blowing Agent 7 | 80/20 blend of Blowing Agent 2 and Blowing Agent 3 |
| Blowing Agent 8 | 50/50 blend of Blowing Agent 2 and Blowing Agent 5 |
| Isocyanate 1 | A polymeric MDI having a nominal functionality of 2.85, an |
| | NCO content by weight of 31% (as determined in accordance |
| | with ASTM D5155), and a viscosity at 25° C. of 600 cP |
| Isocyanate 2 | A polymeric MDI having a nominal functionality of 3, an NCO |
| | content by weight of 30.9% (as determined in accordance |
| | with ASTM D5155), and a viscosity at 25° C. of from 500- |
| | 1,500 cP |

### EXAMPLES 1-5 AND COMPARATIVE EXAMPLES 1-10

In Examples 1-5 and Comparative Examples 1-10, compositions for preparing foams were prepared. In Examples 1-5 and Comparative Examples 3-10, the particular Organopolysiloxane Resin utilized was first combined with Blowing Agent 6 give a mixture. Each mixture was a transparent solution, which was then combined with the other components to give each particular composition. In Comparative Example 1, there was no Organopolysiloxane Resin utilized. In Comparative Example 2, the Organopolysiloxane Resin was combined with the other components directly rather than first forming the mixture with Blowing Agent 6. The compositions of Examples 1-5 and Comparative Examples 1-10 were formed as two-component (2k) systems, with an isocyanate-reactive component (or polyol component) comprising all components other than the isocyanate. The components and the amounts as utilized in the compositions of Examples 1-5 and Comparative Examples 1-10 are below in Tables 2-4. C.E. indicates Comparative Example.

TABLE 2
Compositions of Examples 1-5:

| Component | Ex. 1 | Ex. 2 | Ex. 3 | Ex. 4 | Ex. 5 |
|---|---|---|---|---|---|
| Isocyanate 1 (g) | 250 | 250 | 250 | 250 | 250 |
| Polyol 1 (g) | 61 | 61 | 61 | 61 | 61 |
| Polyol 2 (g) | 20.2 | 20.2 | 20.2 | 20.2 | 20.2 |
| Flame Retardant 1 | 15 | 15 | 15 | 15 | 15 |
| (g) | | | | | |
| Silicone Surfactant | 3 | 3 | 3 | 3 | 3 |
| 1 (g) | | | | | |
| Blowing Agent 1 (g) | 0.8 | 0.8 | 0.8 | 0.8 | 0.8 |
| Catalyst 1 (g) | 0.95 | 0.95 | 0.95 | 0.95 | 0.95 |
| Catalyst 2 (g) | 1.8 | 1.8 | 1.8 | 1.8 | 1.8 |
| Blowing Agent 6 (g) | 17 | 17 | 17 | 17 | 17 |
| Organopolysiloxane | 4.25 | 11.33 | 0 | 0 | 0 |
| Resin 1 (g) | | | | | |
| Organopolysiloxane | 0 | 0 | 4.25 | 11.33 | 0 |
| Resin 2 (g) | | | | | |
| Organopolysiloxane | 0 | 0 | 0 | 0 | 4.25 |
| Resin 3 (g) | | | | | |

TABLE 3
Compositions of Comparative Examples 1-5:

| Component | C.E. 1 | C.E. 2 | C.E. 3 | C.E. 4 | C.E. 5 |
|---|---|---|---|---|---|
| Isocyanate 1 (g) | 250 | 250 | 250 | 250 | 250 |
| Polyol 1 (g) | 61 | 61 | 61 | 61 | 61 |
| Polyol 2 (g) | 20.2 | 20.2 | 20.2 | 20.2 | 20.2 |
| Flame Retardant 1 | 15 | 15 | 15 | 15 | 15 |
| (g) | | | | | |
| Silicone Surfactant | 3 | 3 | 3 | 3 | 3 |
| 1 (g) | | | | | |
| Blowing Agent 1 (g) | 0.8 | 0.8 | 0.8 | 0.8 | 0.8 |
| Catalyst 1 (g) | 0.95 | 0.95 | 0.95 | 0.95 | 0.95 |
| Catalyst 2 (g) | 1.8 | 1.8 | 1.8 | 1.8 | 1.8 |
| Blowing Agent 6 (g) | 17 | 17 | 17 | 17 | 17 |
| Organopolysiloxane | 0 | 7.29 | 0 | 0 | 0 |
| Resin 1 (g) | | | | | |
| Organopolysiloxane | 0 | 0 | 4.25 | 11.33 | 0 |
| Resin 4 (g) | | | | | |
| Organopolysiloxane | 0 | 0 | 0 | 0 | 4.25 |
| Resin 5 (g) | | | | | |

TABLE 4
Compositions of Comparative Examples 6-10:

| Component | C.E. 6 | C.E. 7 | C.E. 8 | C.E. 9 | C.E. 10 |
|---|---|---|---|---|---|
| Isocyanate 1 (g) | 250 | 250 | 250 | 250 | 250 |
| Polyol 1 (g) | 61 | 61 | 61 | 61 | 61 |
| Polyol 2 (g) | 20.2 | 20.2 | 20.2 | 20.2 | 20.2 |
| Flame Retardant 1 | 15 | 15 | 15 | 15 | 15 |
| (g) | | | | | |
| Silicone Surfactant | 3 | 3 | 3 | 3 | 3 |
| 1 (g) | | | | | |
| Blowing Agent 1 (g) | 0.8 | 0.8 | 0.8 | 0.8 | 0.8 |
| Catalyst 1 (g) | 0.95 | 0.95 | 0.95 | 0.95 | 0.95 |
| Catalyst 2 (g) | 1.8 | 1.8 | 1.8 | 1.8 | 1.8 |
| Blowing Agent 6 (g) | 17 | 17 | 17 | 17 | 17 |
| Organopolysiloxane | 4.25 | 0 | 0 | 0 | 0 |
| Resin 5 (g) | | | | | |
| Organopolysiloxane | 0 | 4.25 | 11.33 | 0 | 0 |
| Resin 6 (g) | | | | | |
| Organopolysiloxane | 0 | 0 | 0 | 4.25 | 11.33 |
| Resin 7 (g) | | | | | |

Foams were prepared with the compositions of Examples 1-5 and Comparative Examples 1-10. In particular, each composition was a two component (2k) system, and each isocyanate-reactive (polyol) component was formed first. As noted above, in Examples 1-5 and Comparative Examples 3-10, the particular Organopolysiloxane Resin was first combined with the Blowing Agent 6 to give a mixture prior to combining the mixture with the other components to give the isocyanate-reactive (polyol) component. After combining the components of each isocyanate-reactive (polyol) component, each isocyanate-reactive (polyol) component was mixed for 1-2 minutes at 3,000 revolutions per minute (rpm). Each isocyanate-reactive (polyol) component was then disposed in a 500 mL bottle, and the Isocyanate Component (consisting of Isocyanate 1) was disposed in the bottle. The contents of the bottle were immediately mixed at 3,000 rpm for 5-6 seconds to give a reaction mixture. A portion of each reaction mixture was disposed in a 40×40×40 cm cubic box, and the remainder of each reaction mixture was disposed in a mold heated to 60° C. The reaction mixture that was disposed in the cubic box formed a free rise foam. The reaction mixture that was disposed in the mold formed a mold foam. Properties of the resulting foams (both the free rise and mold foams) were measured as described above and set forth below in Tables 5-7.

TABLE 5
Properties of Foams of Examples 1-5:

| Property | | Ex. 1 | Ex. 2 | Ex. 3 | Ex. 4 | Ex. 5 |
|---|---|---|---|---|---|---|
| Free Rise | Density (m³/Kg) | 43.9 | 44.1 | 41.6 | 43.3 | 41.7 |
| Foam | K factor (mW/m · K) | 22.1 | 22.8 | 22.4 | 22.0 | 22.5 |
| | Maximum Smoke | 38.2 | 35.4 | n/a | n/a | n/a |
| | density (unitless) | | | | | |
| | LOI (O₂ %) | n/a | n/a | n/a | n/a | n/a |
| Mold Foam | Density (m³/Kg) | 49.0 | 48.0 | n/a | n/a | 47.9 |
| | K factor (mW/m · K) | 21.0 | 19.8 | n/a | 23.3 | 21.0 |
| | Maximum Smoke | 38.8 | 36.6 | n/a | n/a | 38.7 |
| | density (unitless) | | | | | |
| | LOI (O₂ %) | 28.7 | 28.3 | n/a | n/a | n/a |

TABLE 6
Properties of Foams of Comparative Examples 1-5:

| | | C.E. | C.E. | C.E. | C.E. | C.E. |
|---|---|---|---|---|---|---|
| Property | | 1 | 2 | 3 | 4 | 5 |
| Free Rise | Density (m³/Kg) | 41.6 | n/a | n/a | n/a | 43.4 |
| Foam | K factor (mW/m · K) | 23.3 | 24.84 | 29.0 | 37.2 | 28.1 |
| | Maximum Smoke | 45.8 | n/a | 49.9 | 43.3 | 33.5 |
| | density (unitless) | | | | | |
| | LOI (O₂ %) | 28.5 | n/a | 30.3 | n/a | 30.2 |
| Mold Foam | Density (m³/Kg) | 48.8 | n/a | 48.8 | n/a | 48.6 |
| | K factor (mW/m · K) | 21.4 | n/a | 20.2 | 25.3 | 20.7 |
| | Maximum Smoke | 41.0 | n/a | 36.6 | 36.8 | n/a |
| | density (unitless) | | | | | |
| | LOI (O₂ %) | 27.9 | n/a | 27.2 | n/a | 28.2 |

TABLE 7
Properties of Foams of Comparative Examples 6-10:

| | | C.E. | C.E. | C.E. | C.E. | C.E. |
|---|---|---|---|---|---|---|
| Property | | 6 | 7 | 8 | 9 | 10 |
| Free Rise | Density (m³/Kg) | 47.5 | 43.9 | 47.0 | 41.8 | 50.6 |
| Foam | K factor (mW/m · K) | 33.4 | 31.9 | 32.3 | 30.4 | 37.6 |
| | Maximum Smoke | 45.9 | 36.4 | 45.6 | 37.9 | 43.1 |
| | density (unitless) | | | | | |
| | LOI (O₂ %) | 31.2 | n/a | n/a | 30.1 | 30.4 |
| Mold Foam | Density (m³/Kg) | 49.1 | 48.2 | 48.2 | 50.3 | 48.5 |
| | K factor (mW/m · K) | 20.8 | 21.1 | 22.3 | 20.6 | 28.6 |
| | Maximum Smoke | 31.8 | n/a | n/a | 46.5 | 31.6 |
| | density (unitless) | | | | | |
| | LOI (O₂ %) | 27.9 | n/a | n/a | n/a | n/a |

### EXAMPLES 6-9 AND COMPARATIVE EXAMPLES 11-13

In Examples 6-9 and Comparative Examples 11-13, compositions for preparing foams were prepared. In Examples 6-9, Organopolysiloxane Resin 1 was first combined with Blowing Agent 7 or 8 give a mixture. Each mixture was a transparent solution, which was then combined with the other components to give each particular composition. In Comparative Examples 11 and 13, there was no Organopolysiloxane Resin utilized. In Comparative Example 12, the Organopolysiloxane Resin 1 was combined with the other components directly rather than first forming the mixture with Blowing Agent 7 or 8. The compositions of Examples 6-9 and Comparative Examples 11-13 were formed as two-component (2k) systems, with an isocyanate-reactive component (or polyol component) comprising all components other than the isocyanate. The components and the amounts as utilized in the compositions of Examples 6-9 and Comparative Examples 11-13 are below in Tables 8-9. C.E. indicates Comparative Example.

TABLE 8
Compositions of Examples 6-9:

| Component | Ex. 6 | Ex. 7 | Ex. 8 | Ex. 9 |
|---|---|---|---|---|
| Isocyanate 2 (g) | 247 | 247 | 247 | 247 |
| Polyol 3 (g) | 100 | 100 | 100 | 100 |
| Flame Retardant 2 | 15 | 15 | 15 | 15 |
| (g) | | | | |
| Silicone Surfactant | 3 | 3 | 3 | 3 |
| 2 (g) | | | | |
| Blowing Agent 1 (g) | 0.8 | 0.8 | 0.8 | 0.8 |
| Catalyst 1 (g) | 0.95 | 0.95 | 0.95 | 0.95 |
| Catalyst 2 (g) | 1.8 | 1.8 | 1.8 | 1.8 |
| Blowing Agent 7 (g) | 17 | 17 | 17 | 0 |
| Blowing Agent 8 (g) | 0 | 0 | 0 | 17 |
| Organopolysiloxane | 4.25 | 7.29 | 11.33 | 3 |
| Resin 1 (g) | | | | |

TABLE 9
Compositions of Comparative Examples 11-13:

| Component | C.E. 11 | C.E. 12 | C.E. 13 |
|---|---|---|---|
| Isocyanate 2 (g) | 247 | 247 | 247 |
| Polyol 3 (g) | 100 | 100 | 100 |
| Flame Retardant 2 | 15 | 15 | 15 |
| (g) | | | |
| Silicone Surfactant | 3 | 3 | 3 |
| 2 (g) | | | |
| Blowing Agent 1 (g) | 0.8 | 0.8 | 0.8 |
| Catalyst 1 (g) | 0.95 | 0.95 | 0.95 |
| Catalyst 2 (g) | 1.8 | 1.8 | 1.8 |
| Blowing Agent 7 (g) | 17 | 17 | 0 |
| Blowing Agent 8 (g) | 0 | 0 | 17 |
| Organopolysiloxane | 0 | 4.25 | 0 |
| Resin 1 (g) | | | |

Foams were prepared with the compositions of Examples 6-9 and Comparative Examples 11-13. In particular, each composition was a two component (2k) system, and each isocyanate-reactive (polyol) component was formed first. As noted above, in Examples 6-9 Organopolysiloxane Resin 1 was first combined with the Blowing Agent 7 or 8 to give a mixture prior to combining the mixture with the other components to give the isocyanate-reactive (polyol) component. After combining the components of each isocyanate-reactive (polyol) component, they were mixed for 1-2 minutes at 3,000 revolutions per minute (rpm). Each isocyanate-reactive (polyol) component was disposed in a 500 mL bottle, and the Isocyanate Component (consisting of Isocyanate 2) was disposed in the bottle. The contents of the bottle were immediately mixed at 3,000 rpm for 5-6 seconds to give a reaction mixture. About 400 grams of each reaction mixture was disposed in a mold heated to 60° C. to form a mold foam. Comparative Examples 11a and 11b are each based on the composition of Comparative Example 11 but separately tested with different results. Properties of the mold foams were measured as described above and set forth below in Table 10.

TABLE 10
Properties of Foams of Examples 6-9
and Comparative Examples 11-13:

| | | | Tack | | | Average |
|---|---|---|---|---|---|---|
| | Cream | Gel | Free | | | Fire |
| | time | time | time | Density | K factor | Propagation |
| Example: | (s) | (s) | (s) | (m³/Kg) | (mW/m · K) | (cm) |
| Ex. 6 | 11 | 50 | 111 | 40.5 | 19.9 | 8.0 |
| Ex. 7 | 11 | 54 | 125 | 40.3 | 20.2 | 7.5 |
| Ex. 8 | 13 | 61 | 145 | 40.8 | 20.4 | 8.0 |
| Ex. 9 | 13 | 102 | n/a | 49.9 | 19.4 | 7.0 |
| C.E. 11a | 10 | 40 | 82 | 36.1 | 21.2 | 11.5 |
| C.E. 11b | 12 | 68 | n/a | 42.07 | 22.3 | 12 |
| C.E. 12 | 11 | 28 | n/a | 42.5 | 29.4 | 7 |
| C.E. 13 | 12 | 84 | n/a | 52.1 | 19.4 | 13.0 |

### EXAMPLES 10-11 AND COMPARATIVE EXAMPLE 14

In Examples 10-11 and Comparative Example 14, compositions for preparing foams were prepared. In Examples 10-11, Organopolysiloxane Resin 1 was first combined with Blowing Agent 4 give a mixture. Each mixture was a transparent solution, which was then combined with the other components to give each particular composition. In Comparative Example 14, there was no Organopolysiloxane Resin utilized. The compositions of Examples 10-11 and Comparative Example 14 were formed as two-component (2k) systems, with an isocyanate-reactive component (or polyol component) comprising all components other than the isocyanate. The components and the amounts as utilized in the compositions of Examples 10-11 and Comparative Example 14 are below in Table 11. C.E. indicates Comparative Example.

TABLE 11
Compositions of Examples 10-11 and Comparative Example 14:

| Component | Ex. 10 | Ex. 11 | C.E. 14 |
|---|---|---|---|
| Isocyanate 1 (g) | 250 | 250 | 250 |
| Polyol 5 (g) | 61 | 61 | 61 |
| Polyol (4) (g) | 20.2 | 20.2 | 20.2 |
| Flame Retardant 1 (g) | 15 | 15 | 15 |
| Silicone Surfactant 3 (g) | 3 | 3 | 3 |
| Blowing Agent 1 (g) | 0.8 | 0.8 | 0.8 |
| Catalyst 1 (g) | 0.95 | 0.95 | 0.95 |
| Catalyst 2 (g) | 1.8 | 1.8 | 1.8 |
| Blowing Agent 4 (g) | 34 | 34 | 34 |
| Organopolysiloxane | 1.89 | 4.25 | 0 |
| Resin 1 (g) | | | |

Foams were prepared with the compositions of Examples 10-11 and Comparative Example 14. In particular, each composition was a two component (2k) system, and each isocyanate-reactive (polyol) component was formed first. As noted above, in Examples 10-11 Organopolysiloxane Resin 1 was first combined with the Blowing Agent 4 to give a mixture prior to combining the mixture with the other components to give the isocyanate-reactive (polyol) component. After combining the components of each isocyanate-reactive (polyol) component, they were mixed for 1-2 minutes at 3,000 revolutions per minute (rpm). Each isocyanate-reactive (polyol) component was disposed in a 500 mL bottle, and the Isocyanate Component (consisting of Isocyanate 1) was disposed in the bottle. The contents of the bottle were immediately mixed at 3,000 rpm for 5-6 seconds to give a reaction mixture. About 400 grams of each reaction mixture was disposed in a mold heated to 60° C. to form a mold foam. Properties of the mold foams were measured as described above and set forth below in Table 12.

TABLE 12
Properties of Foams of Examples 10-11 and Comparative Example 14:

| | | Maximum | |
|---|---|---|---|
| | | Smoke | |
| | LOI | Density | K factor |
| Example: | (O₂ %) | (unitless) | (mW/m · K) |
| Ex. 10 | 28.6 | 24.7 | 17.2 |
| Ex. 11 | 28.1 | 25.9 | 17.3 |
| C.E. 14 | 29.1 | 33.8 | 16.9 |

### EXAMPLE 12

500 grams of Organopolysiloxane Resin 1 and 300 grams of 5 mm Yttria Zirconia beads were disposed into a 5 L Polypropylene bottle. The bottle was loaded onto rollers for 8 hrs, resulting in a powdered resin. The powdered resin was analyzed by GPC for molecular weight changes between the Organopolysiloxane Resin 1 and the powdered resin. The results are set forth in Table 13 below.

### EXAMPLE 13

500 grams of Organopolysiloxane Resin 1, 50 grams of Aminosilicon Compound, and 300 grams of 5 mm Yttria Zirconia beads were disposed into a 5 L Polypropylene bottle. The bottle was loaded onto rollers for 8 hrs, resulting in a powdered resin. The powdered resin was analyzed by GPC for molecular weight changes between the Organopolysiloxane Resin 1 and the powdered resin. The results are set forth in Table 13 below.

TABLE 13
Molecular Weights of the Powdered Resins of Examples 12 and 13,
and the Organopolysiloxane 1 and Aminosilicon Compound:

| | Mn | Mw | Mz | PD |
|---|---|---|---|---|
| Example 12 | 4179 | 8494 | 16449 | 2.03 |
| Example 13 | 4737 | 9400 | 17522 | 1.98 |
| Organopolysiloxane | 4170 | 8619 | 17077 | 2.07 |
| Resin 1 | | | | |
| Aminosilicon | 307 | 316 | 326 | 1.03 |
| Compound | | | | |

The powdered resins of Examples 12 and 13 were analyzed for siloxy unit content via ²⁹Si NMR, the results of which are shown in Table 14 below. In Table 14, Z is H or alkyl; Me is methyl; R′ is an aminopropyl group, and T′ indicates an H₂NCH₂CH₂CH₂SiO_{3/2} siloxy unit. The values in Table 12 are mole fractions.

TABLE 14
Siloxy unit content of the Powdered Resins of Examples 12 and 13:

| Siloxy Unit | 12 | 13 |
|---|---|---|
| Me₃SiOZ | 0.00 | 0.27 |
| Me₃SiO_{1/2} | 40.73 | 40.88 |
| R'Si(OZ)₃ | 0.00 | 0.25 |
| CH₃(OZ)SiO_{2/2} | 0.00 | 0.97 |
| T' | 0.00 | 1.94 |
| (OZ)SiO_{3/2} | 12.78 | 8.64 |
| SiO_{4/2} | 41.39 | 48.22 |

### EXAMPLES 14 AND 15: ISOCYANATE-REACTIVE COMPONENTS, COMPOSITIONS, AND FOAMS

Isocyanate-reactive components for preparing foams were prepared with the powdered resins of Examples 12 and 13. Table 15 shows the relative amounts of the components in each of the isocyanate-reactive components of Examples 14 and 15, which include all components but for the polyisocyanate utilized in the compositions which cure to give the foams. The values in Table 15 are grams.

The isocyanate-reactive components of Examples 14-15 were prepared as follows: Polyol 2, Silicone Surfactant 1, Flame Retardant 2, Blowing Agent 1, and Catalyst 1 were combined and mixed at 1500 rpm with a pneumatic mixer for 60-90 seconds to give a masterbatch. Catalyst 2 was added to the masterbatch the day of preparing foams, along with the powdered resin of Example 14 or 15, respectively, and blended at 2700 rpm for 15 seconds. Then, Blowing Agent 4 was incorporated and mixed at 1500 rpm for 10 seconds to give the isocyanate-reactive components in Table 15.

TABLE 15
Isocyanate-reactive components of Examples 14 and 15:

| Component | 14 | 15 |
|---|---|---|
| Polyol 2 (g) | 81.2 | 81.2 |
| Silicone Surfactant 1 (g) | 15 | 15 |
| Flame Retardant 2 (g) | 3 | 3 |
| Blowing Agent 1 (g) | 0.8 | 0.8 |
| Catalyst 1 (g) | 0.95 | 0.95 |
| Catalyst 2 (g) | 1.3 | 1.3 |
| Powdered resin of Example | 3.6 | 0 |
| 12 (g) | | |
| Powdered resin of Example | 0 | 3.6 |
| 13 (g) | | |
| Blowing Agent 4 (g) | 17 | 17 |

The Isocyanate-reactive Components of Examples 14-15 as shown in Table 15 above were then combined with Isocyanate 1 by pouring the Isocyanate 1 into the particular Isocyanate-reactive Component and stirring the composition so formed at 2700 rpm for 6 seconds. After stirring, each composition was poured into a 20×20×20 cm cubic box or a 20×20×8 cm mold heated at 50° C. (which was closed upon disposing the composition therein). Use of the cubic box resulted in formation of free rise foams. Use of the mold resulted in molded panels. The molded panels were demolded after 10 minutes.

The compositions formed with the Isocyanate-reactive Components of Examples 14 and 15 were prepared at two different isocyanate levels: one composition included 180 g of Isocyanate 1, and another utilized 250 g of Isocyanate 1. The isocyanate-reactive components were identical regardless of the content of the Isocyanate 1 in each composition.

Properties of the foams formed in the mold are measured in accordance with the tests described above. Tables 16 and 17 below show the properties of the foams so formed in Examples 14-15, based on whether the particular foam was formed with 180 g of Isocyanate 1 or 250 g Isocyanate 1.

TABLE 16
Properties of Foams of Examples 14 and 15 with 180 g Isocyanate 1:

| | | | Density, | lambda @10° C., |
|---|---|---|---|---|
| Example: | CT, secs | GT, secs | Kg/m3 | mW/m K |
| 14 | 9 | 41 | 53 | 24.5 |
| 15 | 8 | 43 | 50.9 | 22 |

TABLE 17
Properties of Foams of Examples 14 and 15 with 250 g Isocyanate 1:

| | | | Density, | lambda @10° C., |
|---|---|---|---|---|
| Example: | CT, secs | GT, secs | Kg/m3 | mW/m K |
| 14 | 8 | 58 | 59.3 | 24.55 |
| 15 | 8 | 51 | 60.9 | 22.31 |

### COMPARATIVE EXAMPLE 15

The isocyanate-reactive components, compositions, and general procedures described above in Examples 14 and 15 are repeated in Comparative Example 15 but without the powdered resin from Example 12 or 13. The isocyanate-reactive component of Comparative Example 15 is identical to that of Example 14 or 15 but for the absence of the powdered resin from Example 12 or 13. Compositions and foams were prepared in Comparative Example 15 in an identical manner as above in Examples 14 and 15, including at the same two isocyanate levels. Table 18 below shows the properties of the foams formed at each isocyanate level for Comparative Example 15.

TABLE 18
Properties of Foams of Comparative Example 15:

| Comparative | Isocyanate | CT, | GT, | Density, | lambda @10° C., |
|---|---|---|---|---|---|
| Example | Level (g) | secs | secs | Kg/m3 | mW/m K |
| 15 | 180 | 9 | 36 | 52 | 24.9 |
| 15 | 250 | 8 | 48 | 57.8 | 24.46 |

It is to be understood that the appended claims are not limited to express and particular compounds, compositions, or methods described in the detailed description, which may vary between particular embodiments which fall within the scope of the appended claims.

1. A composition for preparing a foam, said composition comprising:
(A) a polyol;
(B) a pre-mixture comprising (B1) a silicone resin at least partially solubilized in (B2) a physical blowing agent capable of at least partially solubilizing the silicone resin (B1);
(C) a polyisocyanate; and
(D) a catalyst;
wherein the silicone resin (B1) includes at least 20 mol % (R¹₃SiO_{1/2}) siloxy units and at least 40 mol % of (SiO_{4/2}) siloxy units, each based on the total moles of siloxy units present in the silicone resin (B1), with the proviso that the combined amount of (R¹₃SiO_{1/2}) and (SiO_{4/2}) siloxy units is at least 85 mol % based on the total moles of siloxy units present in the silicone resin (B1), where each R¹ is independently a substituted or unsubstituted hydrocarbyl group.

2. The composition of claim 1, wherein the silicone resin (B1) has the following average formula:
(R¹₃SiO_{1/2})ₐ(R¹₂SiO_{2/2})_{b}(R′R¹SiO_{2/2})_{b′}(R¹SiO_{3/2})_{c}(R′SiO_{3/2})_{c′}(SiO_{4/2})_{d},
wherein subscripts a, b, b′, c, c′, and d are each mole fractions such that a+b+b′+c−c′+d=1, with the provisos that 0.2≤a≤0.6, 0≤b≤0.1, 0≤b′≤0.1, 0≤c≤0.1, 0≤c′≤0.1, 0.4≤d≤0.8, and 0.85≤a+d≤1.0;
wherein each R¹ is independently selected and defined above, and wherein each R′ comprises an independently selected amino group.

3. The composition of claim 2, wherein: (i) a molar ratio of (R¹₃SiO_{1/2}) siloxy units to (SiO_{4/2}) siloxy units in the silicone resin (B1) is from 0.7 to 1.2; (ii) the silicone resin (B1) has a weight-average molecular weight of from 2,000 to 30,000; (iii) the silicone resin (B1) is a solid at 25° C. in the absence of any solvent; (iv) b′+c′>0; (v) each R′ is independently of formula —(CH₂)_{g}N(H)_{f}R¹_{2-f}, where each g is independently from 1 to 30, f is 0, 1, or 2, and R¹ is independently selected and defined above or (vi) any combination of (i) to (v).

4. The composition of claim 1, wherein the silicone resin (B1) has the average formula (R¹₃SiO_{1/2})ₓ(SiO_{4/2})_{y}, wherein each R¹ is independently selected and defined above, 0.2≤x≤0.6, 0.4≤y≤0.8, and x+y=1.

5. The composition of claim 1, wherein the physical blowing agent (B2) is selected from hydrocarbons and halogenated hydrocarbons.

6. The composition of claim 1, wherein: (i) the pre-mixture (B) comprises the silicone resin (B1) in an amount of from greater than 0 to 50 wt. % based on the total weight of the pre-mixture (B); (ii) the pre-mixture (B) consists of the silicone resin (B1) and the physical blowing agent (B2); (iii) the physical blowing agent (B2) solubilizes the silicone resin (B1) such that the pre-mixture (B) is a homogenous solution; or (iv) any combination of (i) to (iii).

7. The composition of claim 1, wherein components (A) and (C) are selected and present to give an isocyanate index of at least 130 such that the foam formed with the composition is further defined as a polyisocyanurate foam.

8. The composition of claim 1, wherein: (i) the polyol (A) comprises a polyether polyol; (ii) the polyol (A) comprises a polyester polyol; (iii) the polyisocyanate (C) comprises polymeric MDI (pMDI); or (iv) any combination of (i) to (iii).

9. The composition of claim 1, wherein components (A), (B), and (D) are present in an isocyanate-reactive component separate from component (C).

10. The composition of claim 1, further comprising at least one optional additive selected from surfactants, silanes, and/or nucleators.

11. A method of preparing the composition of claim 1, said method comprising:
contacting the silicone resin (B1) and the physical blowing agent (B2) to give the pre-mixture (B); and
combining the pre-mixture (B) with components (A), (C), and (D) to give the composition.

12. The method of claim 11, wherein the pre-mixture (B) is combined with component (A) to give an isocyanate-reactive component separate from the polyisocyanate (C).

13. A method of preparing a foam, said method comprising:
mixing a composition, and
curing the composition to give the foam,
wherein the composition is the composition of claim 1.

14. A foam comprising the reaction product of the composition of claim 1.

15. Insulation construction-structural insulated panels, and/or sheathing comprising or formed from the foam of claim 14.
